(19) United States
(12) Patent Application Publication
(10) Pub. No.: US 2025/0289920 A1
(43) Pub. Date: Sep. 18, 2025

(54) GRAFT POLYMERS, METHODS OF MAKING GRAFT POLYMERS, AND USES THEREOF

(71) Applicant: VIRGINIA TECH INTELLECTUAL PROPERTIES, INC., Blacksburg, VA (US)

(72) Inventors: Kevin J. Edgar, Blacksburg, VA (US); Jeffrey E. Thompson, Blacksburg, VA (US); Robert B. Moore, Blacksburg, VA (US); Isabela Trindade Coutinho, Blacksburg, VA (US)

(21) Appl. No.: 19/081,036

(22) Filed: Mar. 17, 2025

Related U.S. Application Data
(60) Provisional application No. 63/565,933, filed on Mar. 15, 2024.
(60) Provisional application No. 63/682,039, filed on Aug. 12, 2024.

(51) Int. Cl. C08F 289/00; C08B 30/12; C08B 33/02; C08G 63/08

(52) U.S. Cl. CPC C08F 289/00; C08B 30/12; C08B 33/02; C08G 63/08; C08G 2230/00

(57) ABSTRACT

In one aspect, the disclosure relates to graft polymers and methods of making graft polymers. In one aspect, the graft polymers comprise a backbone polymer and at least one branch polymer attached to the backbone polymer, where the backbone polymer comprises repeating anhydroglucose units or a derivative thereof and the branch polymer comprises a residue of an aliphatic polyester. In another aspect, the graft polymers comprise at least two repeating units. This abstract is intended as a scanning tool for purposes of searching in the particular art and is not intended to be limiting of the present disclosure.

### CROSS REFERENCE TO RELATED APPLICATIONS

This application claims the benefit of and priority to both U.S. Provisional Application No. 63/565,933, filed on Mar. 15, 2024 and U.S. Provisional Application No. 63/682,039, filed on Aug. 12, 2024, both of which are incorporated herein by reference in their entirety.

### STATEMENT ON FUNDING PROVIDED BY THE U.S. GOVERNMENT

This invention was made with Government support under contract DMR 1933525 awarded by the National Science Foundation. The Government has certain rights in the invention.

### BACKGROUND

Concerns over the introduction of petroleum-based plastic waste and prevalence of microplastics in the environment fuels a desire to divest from such non-degradable materials. In particular, there is interest in developing renewably sourced and/or environmentally degradable (i.e., compostable) materials to replace the role of non-degradable plastics. However, more sustainable materials are often restricted in their application, as they suffer from problems such as lower toughness, poor melt processability, and/or higher water sensitivity compared to petroleum-sourced plastics. Despite advances in polymer research, there are still a scarcity of polymer blends that can be used to produce environmentally sustainable and/or biodegradable plastic products. The needs and other needs are satisfied by the present disclosure.

### SUMMARY

In accordance with the purpose(s) of the disclosure, as embodied and broadly described herein, the disclosure, in one aspect, relates to graft polymers and methods of making graft polymers. In one aspect, disclosed are graft polymers comprising a backbone polymer and at least one branch polymer attached to the backbone polymer, wherein the backbone polymer comprises repeating anhydroglucose units or a derivative thereof and the branch polymer comprises a residue of an aliphatic polyester. In another aspect, disclosed are graft polymers comprising at least two repeating units with formulas represented by the following structures:

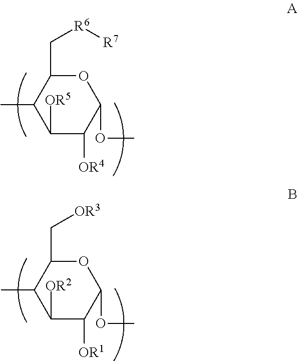

wherein, R¹, R², R³, R⁴, and R⁵ are independently selected from hydrogen, an alkyl group, or an acyl group; R⁶ is a linking agent selected from a secondary amine, a tertiary amine, an aryl group, acyl group, or a thioether; and R⁷ is a residue of an aliphatic polyester.

In another aspect, disclosed are methods for making a polymer, comprising: mixing together a first polymer and a first organic solvent, thereby forming a first mixture; mixing together the first mixture, a first solution, and a second solution, thereby forming a second mixture; mixing together the second mixture and a carboxylic acid anhydride, thereby forming a third mixture comprising an esterified polymer; and isolating the esterified polymer from the third mixture; wherein the first solution comprises triphenylphosphine (PPh₃) and a second organic solvent; wherein the second solution comprises N-bromosuccinimide (NBS) and a third organic solvent; and wherein the first polymer comprises repeating units of anhydroglucose or a derivative thereof.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described aspects are usable in all aspects of the disclosure taught herein. Furthermore, the individual features of the dependent claims, as well as all optional and preferred features and modifications of the described aspects are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1A shows a representative ¹H NMR spectrum of alkyne-terminated poly(L-lactide) (PLLA).

FIGS. 1B-1C show representative size exclusion chromatography chromatograms of alkyne-terminated PLLA (FIG. 1B) and alkyne-terminated poly(D,L-lactide) (PDLLA) (FIG. 1C).

FIG. 2A shows representative stacked ¹H NMR spectra of 2,3-O-acetyl-6-azido-6-deoxy (2,3Ac-6N₃) amylose, alkyne-terminated PLLA, and AmAc-g-PLLA.

FIG. 2B shows representative stacked Fourier transform infrared spectra of 2,3Ac-6N₃ amylose, alkyne-terminated PLLA, and AmAc-g-PLLA (FIG. 2B).

FIGS. 3A-3B shows representative diffusion ordered spectroscopy plots of a mixture of 2,3Ac-6N₃ amylose and alkyne-terminated PDLLA (FIG. 3A) and AmAc-g-PDLLA (FIG. 3B).

FIGS. 4A-4B show representative stacked differential scanning calorimetry thermograms of 2,3Ac-6N₃ amylose, alkyne-terminated PLLA, and AmAc-g-PLLA (FIG. 4A) and of AmAc-g-PDLLA with varying graft densities (FIG. 4B).

FIGS. 5A-5C show representative small-angle laser light scattering patterns and phase contrast optical microscopy images for solution cast blends containing 70/30 StAc/PDLLA with no AmAc-g-PDLLA (FIG. 5A); solution cast blends of 70/30 StAc/PDLLA containing 5 wt % of AmAc-g-PDLLA with 0.5% grafting density with a 29.4 kg/mol PDLLA side chain (FIG. 5B); and solution cast blends of 70/30 StAc/PDLLA containing 5 wt % of AmAc-g-PDLLA with 1% graft density with a 29.4 kg/mol side chain (FIG. 5C).

FIG. 5D shows a graphical representation of the changes in interdomain distance of uncompatibilized blends and blends compatibilized with AmAc-g-PDLLA.

FIG. 6 shows a representative stacked Fourier transform infrared spectra of unmodified Merrifield resin, PS—N₃ resin, and PS—N₃ resin after scavenging PLLA-10.6 k.

FIG. 7 shows a representative ¹H NMR spectrum of AmAc_{2.96}-g_{0.01}-PDLLA-29.4 k.

FIG. 8 shows a representative ¹H NMR spectrum of AmAc_{2.81}-g_{0.19}-PDLLA-29.4 k.

FIG. 9 shows a representative ¹³C NMR spectrum of AmAc_{2.81}-g_{0.19}-PLLA-5.2 k.

FIG. 10 shows a representative stacked Fourier transform infrared spectra of 2,3Ac-6N₃ amylose_{2.96}/0.04, PDLLA-15.4 k, and AmAc_{2.96}-g_{0.04}-PDLLA-15.4 k.

FIG. 11 shows representative stacked differential scanning calorimetry thermograms of alkyne-terminated PDLLA with varying Mₙ.

FIG. 12A shows a representative plot of T_{g} vs. Mₙ for PLLA and PDLLA.

FIG. 12B shows a representative Fox-Flory plot of 1/T_{g} vs. Mₙ for PLLA and PDLLA.

FIG. 13 shows representative stacked differential scanning calorimetry thermograms of 2,3Ac-6N₃ amylose_{2.96/0.04}, PLLA-18.9 k, and AmAc_{2.96}-g_{0.04}-PLLA-18.9 k.

FIG. 14 shows representative stacked differential scanning calorimetry thermograms of 2,3Ac-6N₃ amylose_{2.81/0.19}, PLLA-5.2 k, and AmAc_{2.81}-g_{0.19}-PLLA-5.2 k.

FIG. 15 shows representative stacked differential scanning calorimetry thermograms of PLLA-8.5 k and AmAc_{2.88}-g_{0.12}-PLLA-8.5 k.

FIG. 16 shows representative stacked thermogravimetric analysis thermograms of PDLLA, StAc, and AmAc-g-PDLLA-29.4 k with varying graft density.

FIG. 17 shows variable graft length and variable graft density for graft polymers.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

This disclosure is not limited to particular embodiments described, and as such may, of course, vary. The terminology used herein serves the purpose of describing particular embodiments only, and is not intended to be limiting, since the scope of the present disclosure will be limited only by the appended claims.

Where a range of values is provided, each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Embodiments of the present disclosure will employ, unless otherwise indicated, techniques of organic chemistry, polymer chemistry, and the like, which are within the skill of the art. Such techniques are explained fully in the literature.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1 percent to about 5 percent” should be interpreted to include not only the explicitly recited concentration of about 0.1 weight percent to about 5 weight percent but also include individual concentrations (e.g., 1 percent, 2 percent, 3 percent, and 4 percent) and the sub-ranges (e.g., 0.5 percent, 1.1 percent, 2.2 percent, 3.3 percent, and 4.4 percent) within the indicated range. The term “about” can include traditional rounding according to significant figures of the numerical value. In addition, the phrase “about ‘x’ to ‘y’” includes “about ‘x’ to about ‘y’”.

Furthermore, the terms “about”, “approximate”, “at or about”, and “substantially” as used herein mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

Before the embodiments of the present disclosure are described in detail, it is to be understood that, unless otherwise indicated, the present disclosure is not limited to particular materials, reagents, reaction materials, manufacturing processes, dimensions, frequency ranges, applications, or the like, as such can vary. It is also to be understood that the terminology used herein is for purposes of describing particular embodiments only, and is not intended to be limiting. It is also possible in the present disclosure that steps can be executed in different sequence, where this is logically possible. It is also possible that the embodiments of the present disclosure can be applied to additional embodiments involving measurements beyond the examples described herein, which are not intended to be limiting. It is furthermore possible that the embodiments of the present disclosure can be combined or integrated with other measurement techniques beyond the examples described herein, which are not intended to be limiting.

It should be noted that, as used in the specification and the appended claims, the singular forms “a,” “an,” and “the” include plural referents unless the context clearly dictates otherwise. Thus, for example, reference to “a solvent” may include a plurality of solvents. In this specification and in the claims that follow, reference will be made to a number of terms that shall be defined to have the following meanings unless a contrary intention is apparent.

Each of the applications and patents cited in this text, as well as each document or reference cited in each of the applications and patents (including during the prosecution of each issued patent; “application cited documents”), and each of the PCT and foreign applications or patents corresponding to and/or claiming priority from any of these applications and patents, and each of the documents cited or referenced in each of the application cited documents, are hereby expressly incorporated herein by reference. Further, documents or references cited in this text, in a Reference List before the claims, or in the text itself; and each of these documents or references (“herein cited references”), as well as each document or reference cited in each of the herein-cited references (including, for example, any manufacturer's specifications, instructions, etc.) are hereby expressly incorporated herein by reference.

Prior to describing the various embodiments, the following definitions are provided and should be used unless otherwise indicated.

### Definitions

It is understood that “substitution” or “substituted” includes the implicit proviso that such substitution is in accordance with permitted valence of the substituted atom and the substituent, and that the substitution results in a stable compound, i.e., a compound that does not spontaneously undergo transformation such as by rearrangement, cyclization, or elimination.

It will be understood by those skilled in the art that the moieties substituted can themselves be substituted, if appropriate. For instance, the substituents of a substituted alkyl may include halogen, hydroxy, nitro, thiols, amino, azido, imino, amido, phosphoryl (including phosphonate and phosphinate), sulfonyl (including sulfate, sulfonamido, sulfamoyl and sulfonate), and silyl groups, as well as ethers, alkylthios, carbonyls (including ketones, aldehydes, carboxylates, and esters), —CF₃, —CN and the like. Cycloalkyls can be substituted in the same manner.

The term “acyl” as used herein, alone or in combination, refers to a carbonyl or thiocarbonyl group bonded to a radical selected from, for example, optionally substituted, hydrogen, alkyl (e.g. haloalkyl), alkenyl, alkynyl, alkoxy (“acyloxy” including acetyloxy, butyryloxy, iso-valeryloxy, phenylacetyloxy, benzoyloxy, p-methoxybenzoyloxy, and substituted acyloxy such as alkoxyalkyl and haloalkoxy), aryl, halo, heterocyclyl, heteroaryl, sulfonyl (e.g. allylsulfinylalkyl), sulfonyl (e.g. alkylsulfonylalkyl), cycloalkyl, cycloalkenyl, thioalkyl, thioaryl, amino (e.g., alkylamino or dialkylamino), and aralkoxy. Illustrative examples of “acyl” radicals are formyl, acetyl, 2-chloroacetyl, 2-bromacetyl, benzoyl, trifluoroacetyl, phthaloyl, malonyl, nicotinyl, and the like.

The terms “alkoxyl” or “alkoxyalkyl” as used herein refer to an alkyl-O— group wherein alkyl is as described herein. The term “alkoxyl” as used herein can refer to C₁₋₂₀ inclusive, linear, branched, or cyclic, saturated or unsaturated oxo-hydrocarbon chains, including, for example, methoxyl, ethoxyl, propoxyl, isopropoxyl, n-butoxyl, t-butoxyl, and pentoxyl.

The term “alkyl”, either alone or within other terms such as “thioalkyl” and “arylalkyl”, as used herein, means a monovalent, saturated hydrocarbon radical which may be a straight chain (i.e. linear) or a branched chain. The term “hydroxyalkyl” specifically refers to an alkyl group that is substituted with one or more hydroxy groups. When “alkyl” is used in one instance and a specific term such as “hydroxyalkyl” is used in another, it is not meant to imply that the term “alkyl” does not also refer to specific terms such as “hydroxyalkyl” and the like. An alkyl radical for use in the present disclosure generally comprises from about 1 to 20 carbon atoms, particularly from about 1 to 10, 1 to 8 or 1 to 7, more particularly about 1 to 6 carbon atoms, or 3 to 6. Illustrative alkyl radicals include methyl, ethyl, n-propyl, n-butyl, n-pentyl, n-hexyl, isopropyl, isobutyl, isopentyl, amyl, sec-butyl, tert-butyl, tert-pentyl, n-heptyl, n-octyl, n-nonyl, n-decyl, undecyl, n-dodecyl, n-tetradecyl, pentadecyl, n-hexadecyl, heptadecyl, n-octadecyl, nonadecyl, eicosyl, dosyl, n-tetracosyl, and the like, along with branched variations thereof. In certain aspects of the disclosure an alkyl radical is a C₁-C₆ lower alkyl comprising or selected from the group consisting of methyl, ethyl, n-propyl, n-butyl, n-pentyl, n-hexyl, isopropyl, isobutyl, isopentyl, amyl, tributyl, sec-butyl, tert-butyl, tert-pentyl, and n-hexyl. An alkyl radical may be optionally substituted with substituents as defined herein at positions that do not significantly interfere with the preparation of compounds of the disclosure and do not significantly reduce the efficacy of the compounds. In certain aspects of the disclosure, an alkyl radical is substituted with one to five substituents including halo, lower alkoxy, lower aliphatic, a substituted lower aliphatic, hydroxy, cyano, nitro, thio, amino, keto, aldehyde, ester, amide, substituted amino, carboxyl, sulfonyl, sulfuryl, sulfenyl, sulfate, sulfoxide, substituted carboxyl, halogenated lower alkyl (e.g. CF₃), halogenated lower alkoxy, hydroxycarbonyl, lower alkoxycarbonyl, lower alkylcarbonyloxy, lower alkylcarbonylamino, cycloaliphatic, substituted cycloaliphatic, or aryl (e.g., phenylmethyl benzyl)), heteroaryl (e.g., pyridyl), and heterocyclic (e.g., piperidinyl, morpholinyl). Substituents on an alkyl group may themselves be substituted.

The term “cycloalkyl” as used herein is a non-aromatic carbon-based ring composed of at least three carbon atoms. Examples of cycloalkyl groups include, but are not limited to, cyclopropyl, cyclobutyl, cyclopentyl, cyclohexyl, norbornyl, and the like. The term “heterocycloalkyl” is a type of cycloalkyl group as defined above and is included within the meaning of the term “cycloalkyl,” where at least one of the carbon atoms of the ring is replaced with a heteroatom such as, but not limited to, nitrogen, oxygen, sulfur, or phosphorus. The cycloalkyl group and heterocycloalkyl group can be substituted or unsubstituted. The cycloalkyl group and heterocycloalkyl group can be substituted with one or more groups including, but not limited to, alkyl, cycloalkyl, alkoxy, amino, ether, halide, hydroxy, nitro, silyl, sulfo-oxo, or thiol as described herein.

The term “alkenyl” as used herein is a hydrocarbon group of from 2 to 24 carbon atoms or 2 to 8 carbon atoms or 2 to 6 carbon atoms with a structural formula containing at least one carbon-carbon double bond. Asymmetric structures such as (R¹R²)C═C(R³R⁴) are intended to include both the E and Z isomers. This can be presumed in structural formulae herein wherein an asymmetric alkene is present, or it can be explicitly indicated by the bond symbol C═C. The alkenyl group can be substituted with one or more groups including, but not limited to, alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol, as described herein.

The term “cycloalkenyl” as used herein is a non-aromatic carbon-based ring composed of at least three carbon atoms and containing at least one carbon-carbon double bound, i.e., C═C. Examples of cycloalkenyl groups include, but are not limited to, cyclopropenyl, cyclobutenyl, cyclopentenyl, cyclopentadienyl, cyclohexenyl, cyclohexadienyl, norbornenyl, and the like. The term “heterocycloalkenyl” is a type of cycloalkenyl group as defined above and is included within the meaning of the term “cycloalkenyl,” where at least one of the carbon atoms of the ring is replaced with a heteroatom such as, but not limited to, nitrogen, oxygen, sulfur, or phosphorus. The cycloalkenyl group and heterocycloalkenyl group can be substituted or unsubstituted. The cycloalkenyl group and heterocycloalkenyl group can be substituted with one or more groups including, but not limited to, alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol as described herein.

As used herein, “alkynyl” or “alkynyl group” refers to straight or branched chain hydrocarbon groups having 2 to 40, 2 to 20, 2 to 10, or 2 to 5 carbon atoms and at least one triple carbon to carbon bond, such as ethynyl. Reference to “alkynyl” or “alkynyl group” includes unsubstituted and substituted forms of the hydrocarbon moiety.

The term “cycloalkynyl” as used herein is a non-aromatic carbon-based ring composed of at least seven carbon atoms and containing at least one carbon-carbon triple bond. Examples of cycloalkynyl groups include, but are not limited to, cyclooctynyl, cyclononynyl, and the like. The term “heterocycloalkynyl” is a type of cycloalkenyl group as defined above and is included within the meaning of the term “cycloalkynyl,” where at least one of the carbon atoms of the ring is replaced with a heteroatom such as, but not limited to, nitrogen, oxygen, sulfur, or phosphorus. The cycloalkynyl group and heterocycloalkynyl group can be substituted or unsubstituted. The cycloalkynyl group and heterocycloalkynyl group can be substituted with one or more groups including, but not limited to, alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol as described herein.

The Ar (e.g., Ar₁, Ar₂, etc.) group is an aromatic system or group such as an aryl group. “Aryl”, as used herein, refers to C₅-C₂₀-membered aromatic, heterocyclic, fused aromatic, fused heterocyclic, biaromatic, or bihetereocyclic ring systems. In an aspect, “aryl”, can include 5-, 6-, 7-, 8-, 9-, and 10-membered single-ring aromatic groups that may include from zero to four heteroatoms, for example, functional groups that correspond to benzene, pyrrole, furan, thiophene, imidazole, oxazole, thiazole, triazole, pyrazole, pyridine, pyrazine, pyridazine and pyrimidine, and the like. Those aryl groups having heteroatoms in the ring structure may also be referred to as “aryl heterocycles” or “heteroaromatics”. The aromatic ring can be substituted at one or more ring positions with one or more substituents including, but not limited to, halogen, azide, alkyl, aralkyl, alkenyl, alkynyl, cycloalkyl, hydroxyl, alkoxyl, amino (or quaternized amino), nitro, sulfhydryl, imino, amido, phosphonate, phosphinate, carbonyl, carboxyl, silyl, ether, alkylthio, sulfonyl, sulfonamido, ketone, aldehyde, ester, heterocyclyl, aromatic or heteroaromatic moieties, —CF₃, —CN; and combinations thereof.

The term “aryl” also includes polycyclic ring systems (C₅-C₃₀) having two or more cyclic rings in which two or more carbons are common to two adjoining rings (i.e., “fused rings”) wherein at least one of the rings is aromatic, e.g., the other cyclic ring or rings can be cycloalkyls, cycloalkenyls, cycloalkynyls, aryls and/or heterocycles. Examples of heterocyclic rings include, but are not limited to, benzimidazolyl, benzofuranyl, benzothiofuranyl, benzothiophenyl, benzoxazolyl, benzoxazolinyl, benzthiazolyl, benztriazolyl, benztetrazolyl, benzisoxazolyl, benzisothiazolyl, benzimidazolinyl, carbazolyl, 4aH carbazolyl, carbolinyl, chromanyl, chromenyl, cinnolinyl, decahydroquinolinyl, 2H,6H-1,5,2-dithiazinyl, dihydrofuro[2,3 b]tetrahydrofuran, furanyl, furazanyl, imidazolidinyl, imidazolinyl, imidazolyl, 1H-indazolyl, indolenyl, indolinyl, indolizinyl, indolyl, 3H-indolyl, isatinoyl, isobenzofuranyl, isochromanyl, isoindazolyl, isoindolinyl, isoindolyl, isoquinolinyl, isothiazolyl, isoxazolyl, methylenedioxyphenyl, morpholinyl, naphthyridinyl, octahydroisoquinolinyl, oxadiazolyl, 1,2,3-oxadiazolyl, 1,2,4-oxadiazolyl, 1,2,5-oxadiazolyl, 1,3,4-oxadiazolyl, oxazolidinyl, oxazolyl, oxindolyl, pyrimidinyl, phenanthridinyl, phenanthrolinyl, phenazinyl, phenothiazinyl, phenoxathinyl, phenoxazinyl, phthalazinyl, piperazinyl, piperidinyl, piperidonyl, 4-piperidonyl, piperonyl, pteridinyl, purinyl, pyranyl, pyrazinyl, pyrazolidinyl, pyrazolinyl, pyrazolyl, pyridazinyl, pyridooxazole, pyridoimidazole, pyridothiazole, pyridinyl, pyridyl, pyrimidinyl, pyrrolidinyl, pyrrolinyl, 2H-pyrrolyl, pyrrolyl, quinazolinyl, quinolinyl, 4H-quinolizinyl, quinoxalinyl, quinuclidinyl, tetrahydrofuranyl, tetrahydroisoquinolinyl, tetrahydroquinolinyl, tetrazolyl, 6H-1,2,5-thiadiazinyl, 1,2,3-thiadiazolyl, 1,2,4-thiadiazolyl, 1,2,5-thiadiazolyl, 1,3,4-thiadiazolyl, thianthrenyl, thiazolyl, thienyl, thienothiazolyl, thienooxazolyl, thienoimidazolyl, thiophenyl and xanthenyl. One or more of the rings can be substituted as defined above for “aryl”.

The term “carboxyl” as used herein, alone or in combination, refers to —C(O)OR₂₅— or —C(—O)OR₂₅ wherein R₂₅ is hydrogen, alkyl, alkenyl, alkynyl, cycloalkyl, cycloalkenyl, amino, thiol, aryl, heteroaryl, thioalkyl, thioaryl, thioalkoxy, a heteroaryl, or a heterocyclic, which may optionally be substituted. In aspects of the disclosure, the carboxyl groups are in an esterified form and may contain as an esterifying group lower alkyl groups. In particular aspects of the disclosure, —C(O)OR₂₅ provides an ester or an amino acid derivative. An esterified form is also particularly referred to herein as a “carboxylic ester”. In aspects of the disclosure a “carboxyl” may be substituted, in particular substituted with allyl which is optionally substituted with one or more of amino, amine, halo, alkylamino, aryl, carboxyl, or a heterocyclic. Examples of carboxyl groups are methoxycarbonyl, butoxycarbonyl, tert-alkoxycarbonyl such as tert-butoxycarbonyl, arylmethyoxycarbonyl having one or two aryl radicals including without limitation phenyl optionally substituted by for example lower alkyl, lower alkoxy, hydroxyl, halo, and/or nitro, such as benzyloxycarbonyl, methoxybenzyloxycarbonyl, diphenylmethoxycarbonyl, 2-bromoethoxycarbonyl, 2-iodoethoxycarbonyltert.butylcarborlyl, 4-nitrobenzyloxycarbonyl, diphenylmethoxy-carbonyl, benzhydroxycarbonyl, di-(4-methoxyphenyl-methoxycarbonyl, 2-bromoethoxycarbonyl, 2-iodoethoxycarbonyl, 2-trimethylsilylethoxycarbonyl, or 2-triphenylsilylethoxycarbonyl. Additional carboxyl groups in esterified form are silyloxycarbonyl groups including organic silyloxycarbonyl. The silicon substituent in such compounds may be substituted with lower alkyl (e.g. methyl), alkoxy (e.g. methoxy), and/or halo (e.g. chlorine). Examples of silicon substituents include trimethylsilyl and dimethyltert-butylsilyl. In aspects of the disclosure, the carboxyl group may be an alkoxy carbonyl, in particular methoxy carbonyl, ethoxy carbonyl, isopropoxy carbonyl, t-butoxycarbonyl, t-pentyloxycarbonyl, heptyloxy carbonyl, especially methoxy carbonyl or ethoxy carbonyl.

The term “ester” as used herein is represented by the formula —OC(O)A¹ or —C(O)OA¹, where A¹ can be alkyl, cycloalkyl, alkenyl, cycloalkenyl, alkynyl, cycloalkynyl, aryl, or heteroaryl group as described herein. The term “polyester” as used herein is represented by the formula -(A¹O(O)C-A²-C(O)O)ₐ or -(A¹O(O)C-A²-OC(O))ₐ—, where A¹ and A² can be, independently, an alkyl, cycloalkyl, alkenyl, cycloalkenyl, alkynyl, cycloalkynyl, aryl, or heteroaryl group described herein and “a” is an integer from 1 to 500. “Polyester” is as the term used to describe a group that is produced by condensation polymerization between a compound having at least two carboxylic acid groups with a compound having at least two hydroxyl groups.

The term “thioether” as used herein is represented by the formula A¹SA², where A¹ and A² can be, independently, an alkyl, cycloalkyl, alkenyl, cycloalkenyl, alkynyl, cycloalkynyl, aryl, or heteroaryl group described herein. The term “polythioether” as used herein is represented by the formula -(A'S-A²S)ₐ—, where A¹ and A² can be, independently, an alkyl, cycloalkyl, alkenyl, cycloalkenyl, alkynyl, cycloalkynyl, aryl, or heteroaryl group described herein and “a” is an integer of from 1 to 500. Examples of polythioether groups include polyethylene oxide, polypropylene oxide, and polybutylene oxide.

As used herein, the term “residue”, as in a residue of a chemical species (e.g., a residue of an aliphatic polyester), refers to a fragment, group, or substructure of a compound, regardless of how the compound is prepared. For example, a poly(lactic acid) residue in a particular compound has the structure —[C(O)CH(CH₃)O]ₙ—, regardless of whether lactic acid was used to prepare the molecule. A residue can, optionally, be further modified or substituted.

The term “graft polymer”, as used herein, refers to a copolymer in which one or more polymer blocks are connected to a primary polymer chain or polymer backbone as side chains. The side chain polymers differ from the primary polymer chain. For example, the side chain polymers can be derived from different species of a monomer or can be derived from the same species of monomer as the primary polymer chain but with a different composition or sequence distribution of units.

Compounds of the disclosure can be prepared using reactions and methods generally known to the person of ordinary skill in the art, having regard to that knowledge and the disclosure of this application including the Examples. The reactions are performed in solvent appropriate to the reagents and materials used and suitable for the reactions being effected.

It will be understood by those skilled in the art of organic synthesis that the functionality present on the compounds should be consistent with the proposed reaction steps. This will sometimes require modification of the order of the synthetic steps or selection of one particular process scheme over another in order to obtain a desired compound of the disclosure. It will also be recognized that another major consideration in the development of a synthetic route is the selection of the protecting group used for protection of the reactive functional groups present in the compounds described in this disclosure. An authoritative account describing the many alternatives to the skilled artisan is Greene and Wuts (Protective Groups In Organic Synthesis, Wiley and Sons, 1991).

### Abbreviations

2,3Ac-6N₃ 2,3-O-acetyl-6-azido-6-deoxy
AmAc amylose acetate
AmAc-g-PLA amylose acetate-graft-polylactide
DOSY diffusion ordered spectroscopy
DSC differential scanning calorimetry
FTIR Fourier transform infrared
PCOM phase contrast optical microscopy
PDLLA alkyne-terminated poly(D,L-lactide)
PLA polylactide
PLLA poly(L-lactide)
SALLS small-angle laser light scattering
SEC size exclusion chromatography
StAc starch acetate
T_{g} glass transition temperature

### Discussion

In one aspect, this disclosure relates to graft polymers and methods of making graft polymers comprising anhydroglucose units or derivatives thereof. More specifically, in one aspect, the disclosure relates to graft polymers comprising a backbone polymer and at least one branch polymer attached to the backbone polymer, where the backbone polymer can include repeating anhydroglucose units or derivatives thereof and the branch polymer can include a residue of an aliphatic polyester. Methods for making the graft polymers disclosed herein can allow for selective tuning of the length of the branch polymers (graft length) and grafting frequency of the branch polymers (graft density).

There is interest in developing renewably sourced and/or environmentally degradable (i.e., compostable) materials to replace the role of non-degradable plastics. Such sustainable materials can include compostable polyesters sourced from petroleum feedstocks, such as poly(ε-caprolactone) (PCL) and poly(butylene succinate) (PBS); compostable polyesters sourced from renewable feedstocks, such as poly(lactic acid) (PLA) and poly-3-hydroxybutyrate (PH3B); and naturally occurring biopolymers, such as proteins, cellulose, and derivatives thereof (e.g., starch esters, cellulose esters). However, these sustainable materials often suffer from higher production costs, lower toughness, poor melt processability, and higher water sensitivity than traditional petroleum-sourced plastics. One approach to improve the cost effectiveness and range of physicochemical properties of these polymers is through physical blending with another polymer that has a complementary and/or desirable cost or properties. However, most pairs of polymers are thermodynamically immiscible, resulting in macrophase separation and poor physical properties in the polymer blend.

Immiscible polymer blends, including polysaccharide-based blends, can be improved with regard to mixing and properties by addition of a compatibilizer, such as a graft copolymer. Graft polymers comprise polymers that have segments, each of which is miscible with one of the components of the polymer blend, allowing the compatibilizer to sit at the interface of immiscible phases, reduce interfacial tension, and better stabilize the phase-separated morphology to improve physicochemical properties of the blend. Current methods for producing graft polymers that have potential as blend compatibilizers, such as the synthesis of polyester-grafted polysaccharides, do not allow for structural control of the microstructure and morphology of the resulting blended systems. The methods disclosed herein allow for the synthesis of graft polymers with more control over parameters of the polymer such as graft length and graft density. The graft polymers disclosed herein can be used as compatibilizers in immiscible polymer blends. The polymer blends can be used to produce plastic products. Examples of plastic products include packaging for food, personal care items, medical supplies and devices, and the like; plastics for medical devices, including implants and controlled release systems; films for agriculture and other like applications; cutlery, plates, cups, and the like; and other products, such as those used in restaurants and other settings, in which the entire waste stream (plastics and, for example, food) can be sent to a compositing facility.

### Graft Polymers

The graft polymers disclosed herein can include a backbone polymer and at least one branch polymer attached to the backbone polymer. The backbone polymer can include repeating anhydroglucose units or derivatives thereof and the branch polymer can include a residue of an aliphatic polyester. In one aspect, the branch polymer can include a residue of poly(lactic acid) or a derivative thereof. In one aspect, the graft polymers disclosed herein are high molecular weight polymers (i.e., have a number average molecular weight (Mₙ) of at least 1 kDa). In a further aspect, the graft polymers have an Mₙ of at least about 1 kDa, at least about 300 kDa, at least about 600 kDa, at least about 1000 kDa, at least about 1500 kDa, at least about 2000 kDa, at least about 2500 kDa, at least about 3000 kDa, at least about 3500 kDa, or at least about 4000 kDa. In another aspect, the graft polymers have an Mₙ of about 1 kDa to about 4000 kDa, about 300 kDa to about 4000 kDa, about 400 to about 4000 kDa, about 400 to about 3500 kDa, about 400 to about 3000 kDa, about 1000 to about 4000 kDa, about 1000 to about 3500 kDa, or about 1000 to about 3000 kDa.

The graft polymers disclosed herein can be characterized by the properties of the graft polymer's components, e.g., the branch polymer(s) and the backbone polymer. In one aspect, an individual branch polymer can have an Mₙ that is less than the entanglement molecular weight of the individual branch polymer prior to being grafted onto the backbone polymer. In another aspect, each branch polymer can have an Mₙ that is greater than or equal to the entanglement molecular weight of the branch polymer prior to being grafted onto the backbone polymer. In another aspect, each branch polymer can have an Mₙ of about 5 kDa to about 100 kDa, about 5 kDa to about 75 kDa, about 5 kDa to about 50 kDa, or about 5 kDa to about 25 kDa.

The backbone polymer can have a linear polymer structure or a branched polymer structure. In one aspect, the backbone polymer can have an Mₙ of about 25 kDa to about 500 kDa, about 75 kDa to about 500 kDa, about 100 kDa to about 500 kDa, about 25 kDa to about 400 kDa, about 100 kDa to about 400 kDa, or about 200 kDa to about 400 kDa. In one aspect, the backbone polymer can include residues of amylose, amylopectin, derivatives thereof, or any combination thereof. In another aspect, the backbone polymer can comprise residues of amylopectin, amylopectin acetate, or a derivative thereof and amylose, amylose acetate, or a derivative thereof. In a further aspect, the backbone polymer can range from about 1% to about 40% or about 5% to about 35% amylose, amylose acetate, or a derivative thereof by weight and from about 60% to about 99% or about 70% to about 95% amylopectin, amylopectin acetate, or a derivative thereof by weight. In another aspect, the backbone polymer is starch, starch acetate, or a derivative thereof. In another aspect, the backbone polymer comprises amylose, amylose acetate, or a derivative thereof. In a further aspect, the backbone polymer comprises amylose, amylose acetate, or a derivative thereof, and no amylopectin.

The grafting density (grafting frequency of the branch polymer) can range from about 2% to about 30%, about 2% to about 25%, about 2% to about 20%, about 2% to about 15%, or about 2% to about 10%. For example, a grafting density of 12% corresponds to branch polymers attached approximately every 8 repeat units along the backbone polymer.

In one aspect, the graft polymers disclosed herein comprise repeating units with a formula represented by the following structure:

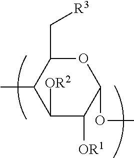

where R¹ and R² can be independently selected from hydrogen, an alkyl group, or an acyl group; R³ can be a hydroxy group, alkyl group, acyl group, or —R⁴Q, wherein R⁴ can be a linking agent selected from a secondary amine, a tertiary amine, an aryl group, an acyl group, or a thioether and Q is the branch polymer. In a further aspect, the graft polymer comprises multiple repeat units of the above structure, where R¹, R², and R³ can be independently selected for each repeat unit of the graft polymer, such that one repeat unit, when compared to a second repeat unit, can have the same R groups, entirely different R groups, or some variation in R groups. In one aspect, R³ is —R⁴Q for at least one repeat unit of the backbone polymer.

In another aspect, R¹ and R² can be independently selected from —C(O)R²⁰, where R²⁰ can be a C₁-C₆ alkyl group. In another aspect, R³ can be selected from —C(O)R²⁰, where R²⁰ is a C₁-C₆ alkyl group, and —R⁴Q, where R⁴ can be a linking agent selected from a secondary amine, a tertiary amine, an aryl group, an acyl group, or a thioether and Q is the branch polymer. In another aspect, R⁴ is an aryl heterocycle. In a further aspect, R⁴ is a substituted or unsubstituted triazole.

In another aspect, the graft polymers disclosed herein comprise repeating units with a formula represented by the following structure:

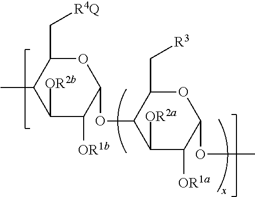

where R^{1a}, R^{2a}, R^{1b}, R^{2b}, and R³ can be independently selected from hydrogen, a hydroxy group, an alkyl group, or an acyl group; R⁴ can be a linking agent selected from a secondary amine, a tertiary amine, an aryl group, an acyl group, or a thioether; Q is the branch polymer; and x can range from 1 to 50. Q, the branch polymer, can be a residue of an aliphatic polyester. In one aspect, Q is poly(lactic) acid.

In another aspect, R^{1a}, R^{2a}, R^{1b}, R^{2b}, and R³ can be independently selected from —C(O)R₂₀, where R₂₀ is a C₁-C₆ alkyl group. In another aspect, R⁴ is an aryl heterocycle. In a further aspect, R⁴ is a substituted or unsubstituted triazole. In another aspect, x can range from 1 to 25, from 1 to 20, from 1 to 10, or from 1 to 5.

In one aspect, the graft polymers disclosed herein comprise repeating units with a formula represented by the following structures:

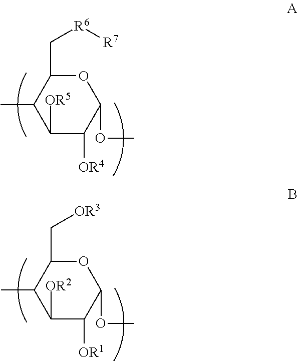

where R¹, R², R³, R⁴, and R⁵ are independently selected from hydrogen, an alkyl group, or an acyl group; R⁶ is a linking agent selected from a secondary amine, a tertiary amine, an aryl group, acyl group, or a thioether; and R⁷ is a residue of an aliphatic polyester.

In another aspect, R¹, R², R³, R⁴, and R⁵ can be independently selected from —C(O)R₂₀, where R₂₀ is a C₁-C₆ alkyl group. In another aspect, R⁶ can be an aryl heterocycle. In a further aspect, R⁶ can be a substituted or unsubstituted triazole. In another aspect, R⁷ is a poly(lactic acid) residue. R⁷ can have an Mₙ of about 5 kDa to about 100 kDa, about 5 kDa to about 75 kDa, about 5 kDa to about 50 kDa, or about 5 kDa to about 25 kDa.

The ratio of repeating units of structure A to repeating units of structure B (A:B) present in the graft polymer can range from about 1:30 to about 1:1, about 1:25 to about 1:1, about 1:25 to about 1:2, about 1:20 to about 1:2, about 1:15 to about 1:2, or about 1:10 to about 1:2.

The graft polymers disclosed herein can act as effective graft polymer compatibilizers for immiscible blends of polymers, where the immiscible blend comprises a polymer with repeating anhydroglucose units (e.g., starch or derivatives thereof) and a polymer comprising a residue of an aliphatic polyester (e.g., poly(lactic acid) or derivatives thereof). Compatibilized blends of polymers that are biodegradable and/or that can be sourced from renewable materials (e.g., starch sourced from renewable starch feedstocks) can be used in the production of more environmentally sustainable plastics and, potentially, the replacement of nondegradable plastics.

### Methods of Making Graft Polymers

Also disclosed herein are methods of making a polymer or graft polymer. In one aspect, this method comprises: mixing together a first polymer and a first organic solvent, thereby forming a first mixture; mixing together the first mixture, a first solution comprising triphenylphosphine (PPh₃) and a second organic solvent, and a second solution comprising N-bromosuccinimide (NBS) and a third organic solvent, thereby forming a second mixture; mixing together the second mixture and a carboxylic acid anhydride, thereby forming a third mixture comprising a brominated-esterified polymer; and isolating the brominated-esterified polymer from the third mixture. The first polymer can comprise repeating units of anhydroglucose or a derivative thereof. In one aspect, the first organic solvent can be anhydrous N,N-dimethylacetamide (DMAc). In one aspect, the second organic solvent and/or the third organic solvent can be DMAc. In one aspect, the carboxylic acid anhydride can be acetic anhydride. In one aspect, all or parts of the method can be performed in an inert atmosphere such as nitrogen or argon.

In another aspect, the method comprises: mixing together a first polymer and a first organic solvent, thereby forming a first mixture; mixing together the first mixture and a first solution comprising methanesulfonyl chloride (MsCl) and a second organic solvent, thereby forming a second mixture; mixing together the second mixture and a carboxylic acid anhydride, thereby forming a third mixture comprising a chlorinated-esterified polymer; and isolating the chlorinated-esterified polymer from the third mixture. The first polymer can comprise repeating units of anhydroglucose or a derivative thereof. In one aspect, the first organic solvent can be anhydrous N,N-dimethylacetamide (DMAc). In one aspect, the second organic solvent can be N,N-dimethylformamide (DMF). In one aspect, the carboxylic acid anhydride can be acetic anhydride. In one aspect, all or parts of the method can be performed in an inert atmosphere such as nitrogen or argon. One example for making a graft polymer by this method is provided in the Examples.

The first mixture can be formed by stirring together the first polymer and an organic solvent (e.g., anhydrous DMAc) under an inert atmosphere (e.g., nitrogen or argon) for about 10 minutes to about 60 minutes at a temperature of about 100° C. to 160° C. Prior to forming the second mixture, LiBr can be added to the first mixture along with, optionally, additional organic solvent and mixed for about 5 minutes to about 30 minutes at a temperature of about 100° C. to 160° C. After either step, the first mixture can be allowed to cool to room temperature prior to forming the second mixture.

In one aspect, the second mixture can be formed by stirring together the first mixture, a PPh₃ solution, and an NBS solution under an inert atmosphere (e.g., nitrogen or argon). This first solution or PPh₃ solution can comprise PPh₃ and an organic solvent (e.g., anhydrous DMAc). The second solution can comprise NBS and an organic solvent (e.g., anhydrous DMAc). Optionally, the solution can be allowed to mix at room temperature prior to adding the carboxylic acid anhydride. After adding the carboxylic acid anhydride and forming the third mixture, the third mixture can be stirred under an inert atmosphere (e.g., nitrogen or argon) for about 12 hours to about 48 hours at a temperature above room temperature (e.g., about 60° C. to about 90° C.). In another aspect, the carboxylic acid anhydride can be added to the first mixture and, optionally, allowed to mix with the first mixture at room temperature, prior to adding the PPh₃ and NBS solutions.

In another aspect, the second mixture can be formed by stirring together the first mixture and a MsCl solution under an inert atmosphere (e.g., nitrogen or argon). Optionally, the second mixture can be stirred at room temperature or at an elevated temperature (e.g., 50° C. to 100° C.) for about 1 hour to about 5 hours. This first solution or MsCl solution can comprise methanesulfonyl chloride and an organic solvent (e.g., DMF). After adding the carboxylic acid anhydride and forming the third mixture, the third mixture can be stirred under an inert atmosphere (e.g., nitrogen or argon) for about 12 hours to about 48 hours at a temperature above room temperature (e.g., about 60° C. to about 90° C.). In another aspect, the carboxylic acid anhydride can be added to the first mixture and, optionally, allowed to mix with the first mixture at room temperature, prior to adding the MsCl solution.

Either the brominated-esterified polymer or the chlorinated-esterified can be isolated from the third mixture by precipitation and filtration steps. For example, a solution comprising an alkyl alcohol (e.g., methanol) and water can be added to the third mixture to precipitate the polymer. Additional steps of redissolving the polymer, re-precipitating the polymer, and filtration can be performed.

In another aspect, the first polymer can comprise amylose, amylopectin, starch, or a derivative thereof. In a further aspect, the first polymer can comprise from about 1% to about 40% or about 5% to about 35% amylose, amylose acetate, or a derivative thereof by weight and from about 60% to about 99% or about 70% to about 95% amylopectin, amylopectin acetate, or a derivative thereof by weight. In another aspect, the first polymer can comprise amylose, amylose acetate, or a derivative thereof and no amylopectin.

In one aspect, the first solution can comprise from about 1 to about 4 or about 1 to about 2 molar equivalents of PPh₃ to 1 molar equivalent of anhydroglucose units present in the first polymer. In another aspect, the first solution can comprise from about 1 to about 10, about 1 to about 8, about 1 to about 6, or about 1 to about 4 molar equivalents of MsCl to 1 molar equivalent of anhydroglucose units present in the first polymer. In one aspect, the second solution can comprise about 1 to about 4 or about 1 to about 2 molar equivalents of NBS to 1 molar equivalent of anhydroglucose units present in the first polymer.

The brominated-esterified polymer can have a degree of substitution of bromide of less than about 0.30, less than about 0.25, less than about 0.20, less than about 0.15, or less than about 0.10. In another aspect, the brominated polymer can have a degree of substitution of bromide of about 0.02 to about 0.30, about 0.02 to about 0.25, about 0.02 to about 0.20, about 0.02 to about 0.15, or about 0.02 to about 0.10. The degree of substitution of bromide is the average number of bromide groups per repeating unit (e.g., anhydroglucose repeat unit) of the brominated polymer.

The chlorinated-esterified polymer can have a degree of substitution of chloride of less than about 0.30, less than about 0.25, less than about 0.20, less than about 0.15, or less than about 0.10. In another aspect, the chlorinated-esterified polymer can have a degree of substitution of chloride of about 0.02 to about 0.30, about 0.02 to about 0.25, about 0.02 to about 0.20, about 0.02 to about 0.15, or about 0.02 to about 0.10. The degree of substitution of chloride is the average number of chloride groups per repeating unit (e.g., anhydroglucose repeat unit) of the chlorinated-esterified polymer.

The method can further comprise dissolving the brominated-esterified polymer or the chlorinated-esterified polymer in an organic solvent, thereby forming an esterified polymer solution; mixing together the esterified polymer solution and an azide salt, such as sodium azide, thereby forming a fourth mixture comprising an azide-functionalized polymer; isolating the azide-functionalized polymer from the fourth mixture; dissolving the azide-functionalized polymer and a aliphatic polyester or an aliphatic polyester derivative in a solvent (e.g., anhydrous DMF) under an inert atmosphere (e.g., nitrogen or argon), thereby forming a graft polymer mixture; mixing together the graft polymer mixture with a catalyst solution, comprising Cu(I)Br, PMDETA, and ascorbic acid, thereby forming a final polymer mixture comprising a graft polymer; and isolating the graft polymer from the final polymer mixture. The graft polymer can be isolated from the final polymer mixture by filtration. Optionally, the graft polymer can be further washed with a nonsolvent such as MeOH. In one aspect, the aliphatic polyester or aliphatic polyester derivative can be poly(lactic acid) or a derivative thereof. In another aspect, the aliphatic polyester derivative is an alkyne-functionalized aliphatic polyester, such as an alkyne-functionalized poly(lactic acid).

The brominated-esterified polymer can be dissolved in a solvent such as dimethyl sulfoxide (DMSO) to form an esterified polymer solution. Similarly, the chlorinated-esterified polymer can be dissolved in a solvent such as DMSO to form an esterified polymer solution. The fourth mixture can be formed by stirring together the esterified polymer solution and sodium azide at a temperature above room temperature (e.g., about 60° C. to about 90° C.) for about 12 hours to about 36 hours. The azide-functionalized polymer can be isolated from the fourth mixture by precipitation, filtration, and, if necessary, additional steps of dissolving, precipitating, and filtering.

The graft polymer mixture can be formed by dissolving the azide-functionalized polymer and an aliphatic polyester or aliphatic polyester derivative (e.g., an alkyne-terminated aliphatic polyester) in a solvent (e.g., anhydrous dimethylformamide). The graft polymer mixture can then be stirred with the catalyst solution in an inert atmosphere at a temperature above room temperature (e.g., 40° C. to about 80° C.) for about 60 hours to about 84 hours. A graft polymer can be isolated from the final polymer mixture by steps of precipitation, filtration and, if necessary, additional steps of dissolving, precipitating, and filtering. Optionally, the final polymer mixture can be mixed with an azide-functionalized polystyrene resin to allow any unreacted aliphatic polyester or aliphatic polyester derivative to conjugate to the resin. The azide-functionalized polystyrene resin can be mixed with the final polymer mixture at a temperature above room temperature (e.g., 40° C. to about 80° C.) for about 60 hours to about 84 hours.

While embodiments of the present disclosure are described in connection with the Examples and the corresponding text and figures, there is no intent to limit the disclosure to the embodiments in these descriptions. On the contrary, the intent is to cover all alternatives, modifications, and equivalents included within the spirit and scope of embodiments of the present disclosure.

### Aspects

The following listing of exemplary aspects supports and is supported by the disclosure provided herein.

Aspect 1. A graft polymer comprising a backbone polymer and at least one branch polymer attached to the backbone polymer, wherein the backbone polymer comprises repeating anhydroglucose units or a derivative thereof and the branch polymer comprises a residue of an aliphatic polyester.

Aspect 2. The graft polymer of aspect 1, wherein the aliphatic polyester is poly(lactic acid) or a derivative thereof.

Aspect 3. The graft polymer of aspect 1 or aspect 2, wherein the graft polymer has a number average molecular weight of about 400 kDa to about 3500 kDa.

Aspect 4. The graft polymer of any one of aspects 1-3, wherein the backbone polymer has a number average molecular weight of about 25 kDa to about 400 kDa.

Aspect 5. The graft polymer of any one of aspects 1-3, wherein each branch polymer has a number average molecular weight of about 5 kDa to about 100 kDa.

Aspect 6. The graft polymer of any one of aspects 1-4, wherein each branch polymer has a number average molecular weight that is less than the entanglement molecular weight of the branch polymer prior to being attached to the backbone polymer.

Aspect 7. The graft polymer of any one of aspects 1-4, wherein the branch polymer has a number average molecular weight that is greater than or equal to the entanglement molecular weight of the branch polymer prior to being attached to the backbone polymer.

Aspect 8. The graft polymer of any one of aspects 1-7, wherein the graft polymer has a grafting density of about 2% to about 30%,

Aspect 9. The graft polymer of any one of aspects 1-7, wherein the graft polymer has a grafting density of about 2% to about 25%.

Aspect 10. The graft polymer of any one of aspects 1-9, wherein the backbone polymer comprises residues of amylose, amylopectin, derivatives thereof, or any combination thereof.

Aspect 11. The graft polymer of any one of aspects 1-9, wherein the backbone polymer comprises residues of amylose, amylose acetate, derivatives thereof, or a combination thereof.

Aspect 12. The graft polymer of any one of aspects 1-9, wherein the backbone polymer comprises from about 1% to about 40% of an amylose residue or a derivative thereof by weight and from about 60% to about 99% of an amylopectin residue or a derivative thereof by weight.

Aspect 13. The graft polymer of any one of aspects 1-9, wherein the backbone polymer is a linear polymer.

Aspect 14. The graft polymer of any one of aspects 1-9, wherein the backbone polymer is a branched polymer.

Aspect 15. The graft polymer of any one of aspects 1-7, wherein the graft polymer comprises repeating units with a formula represented by the following structure:

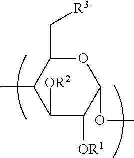

wherein, R¹ and R² are independently selected from hydrogen, an alkyl group, or an acyl group; R³ is a hydroxy group, alkyl group, acyl group, or —R⁴Q, wherein R⁴ is a linking agent selected from a secondary amine, a tertiary amine, an aryl group, an acyl group, or a thioether, and Q is the branch polymer; and R³ is —R⁴Q for at least one repeat unit of the backbone polymer.

Aspect 16. The graft polymer of aspect 15, wherein R¹ and R² are independently selected from —C(O)R²⁰, wherein R²⁰ is a C₁-C₆ alkyl group.

Aspect 17. The graft polymer of aspect 15 or aspect 16, wherein R³ is selected from —C(O)R²⁰, wherein R²⁰ is a C₁-C₆ alkyl group, and —R⁴Q, wherein R⁴ is a linking agent selected from a secondary amine, a tertiary amine, an aryl group, an acyl group, or a thioether and Q is the branch polymer.

Aspect 18. The graft polymer of any one of aspect 15-17, wherein R⁴ is an aryl heterocycle.

Aspect 19. The graft polymer of any one of aspects 15-17, wherein R⁴ is a substituted or unsubstituted triazole.

Aspect 20. The graft polymer of any one of aspects 1-7, wherein the graft polymer comprises repeating units with a formula represented by the following structure:

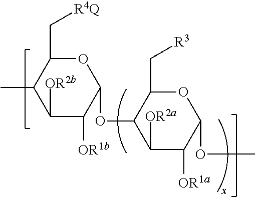

wherein, R^{1a}, R^{2a}, R^{1b}, R²¹, and R³ are independently selected from hydrogen, a hydroxy group, an alkyl group, or an acyl group; R⁴ is a linking agent selected from a secondary amine, a tertiary amine, an aryl group, an acyl group, or a thioether; Q is the branch polymer; and x ranges from 1 to 50.

Aspect 21. The graft polymer of aspect 20, wherein R^{1a}, R^{2a}, R¹R, R^{2b}, and R³ are independently selected from —C(O)R₂₀, wherein R₂₀ is a C₁-C₆ alkyl group.

Aspect 22. The graft polymer of aspect 20 or aspect 21, wherein R⁴ is an aryl heterocycle.

Aspect 23. The graft polymer of aspect 20 or aspect 21, wherein R⁴ is a substituted or unsubstituted triazole.

Aspect 24. The graft polymer of any one of aspects 20-23, wherein x ranges from 1 to 25.

Aspect 25. A graft polymer, comprising at least two repeating units with formulas represented by the following structures:

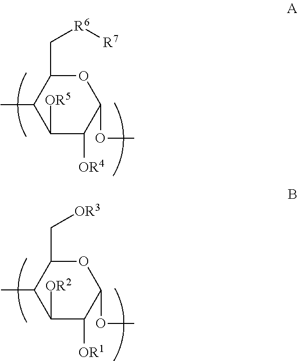

wherein, R¹, R², R³, R⁴, and R⁵ are independently selected from hydrogen, an alkyl group, or an acyl group; R⁶ is a linking agent selected from a secondary amine, a tertiary amine, an aryl group, acyl group, or a thioether; and R⁷ is a residue of an aliphatic polyester.

Aspect 26. The graft polymer of aspect 25, wherein R¹, R², R³, R⁴, and R⁵ are independently selected from —C(O)R₂₀, wherein R₂₀ is a C₁-C₆ alkyl group.

Aspect 27. The graft polymer of aspect 25 or aspect 26, wherein R⁶ is an aryl heterocycle.

Aspect 28. The graft polymer of aspect 25 or aspect 26, wherein R⁶ is a substituted or unsubstituted triazole.

Aspect 29. The graft polymer of any one of aspects 25-28, wherein R⁷ is a poly(lactic acid) residue.

Aspect 30. The graft polymer of any one of aspects 25-29, wherein R⁷ has a number average molecular weight of about 5 kDa to about 100 kDa.

Aspect 31. The graft polymer of any one of aspects 25-30, wherein the ratio of repeating units of structure A to repeating units of structure B present in the graft polymer ranges from about 1:30 to about 1:1 (A:B).

Aspect 32. The graft polymer of any one of aspects 25-30, wherein the ratio of repeating units of structure A to repeating units of structure B present in the graft polymer ranges from about 1:25 to about 1:2 (A:B).

Aspect 33. The graft polymer of any one of aspects 25-32, wherein the graft polymer has a number average molecular weight of about 400 kDa to about 3500 kDa.

Aspect 34. A method for making a polymer, comprising: mixing together a first polymer and a first organic solvent, thereby forming a first mixture; mixing together the first mixture, a first solution, and a second solution, thereby forming a second mixture; mixing together the second mixture and a carboxylic acid anhydride, thereby forming a third mixture comprising an esterified polymer; and isolating the esterified polymer from the third mixture; wherein the first solution comprises triphenylphosphine (PPh₃) and a second organic solvent; wherein the second solution comprises N-bromosuccinimide (NBS) and a third organic solvent; and wherein the first polymer comprises repeating units of anhydroglucose or a derivative thereof.

Aspect 35. The method of aspect 34, wherein the first solution comprises about 1 to about 4 molar equivalents of PPh₃ to 1 molar equivalent of anhydroglucose units present in the first polymer.

Aspect 36. The method of aspect 34 or aspect 35, wherein the second solution comprises about 1 to about 4 molar equivalents of NBS to 1 molar equivalent of anhydroglucose units present in the first polymer.

Aspect 37. The method of any one of aspects 34-36, wherein the esterified polymer has a degree of substitution of bromide of less than about 0.3.

Aspect 38. The method of any one of aspects 34-36, wherein the esterified polymer has a degree of substitution of bromide of about 0.02 to about 0.30.

Aspect 39. A method for making a polymer, comprising: mixing together a first polymer and a first organic solvent, thereby forming a first mixture; mixing together the first mixture and a first solution comprising methanesulfonyl chloride (MsCl) and a second organic solvent, thereby forming a second mixture; mixing together the second mixture and a carboxylic acid anhydride, thereby forming a third mixture comprising an esterified polymer; isolating the esterified polymer from the third mixture; wherein the first polymer comprises repeating units of anhydroglucose or a derivative thereof.

Aspect 40. The method of aspect 39, wherein the second solution comprises about 1 to about 10 molar equivalents of MsCl to 1 molar equivalent of anhydroglucose units present in the first polymer.

Aspect 41. The method of aspect 39 or aspect 40, wherein the esterified polymer has a degree of substitution of chloride of less than about 0.3.

Aspect 42. The method of aspect 39 or aspect 40, wherein the esterified polymer has a degree of substitution of chloride of about 0.02 to about 0.30.

Aspect 43. The method of any one of aspects 34-42, wherein the carboxylic acid anhydride is acetic anhydride.

Aspect 44. The method of any one of aspects 34-43, wherein the first polymer comprises amylose, amylopectin, starch, or a derivative thereof.

Aspect 45. The method of any one of aspects 34-43, wherein the first polymer comprises about 1% to about 40% amylose or a derivative thereof by weight and from about 60% to about 99% amylopectin or a derivative thereof by weight.

Aspect 46. The method of any one of aspects 34-45, further comprising: dissolving the esterified polymer in a solvent, thereby forming an esterified polymer solution; mixing together the esterified polymer solution and an azide salt, thereby forming a fourth mixture comprising an azide-functionalized polymer; isolating the azide-functionalized polymer from the fourth mixture; dissolving the azide-functionalized polymer and an aliphatic polyester or aliphatic polyester derivative in a solvent, thereby forming a graft polymer mixture; mixing together the graft polymer mixture with a catalyst solution, comprising Cu(I)Br, PMDETA, and ascorbic acid, thereby forming a final polymer mixture comprising a graft polymer; and isolating the graft polymer from the final polymer mixture.

Aspect 47. The method of aspect 46, wherein the azide-functionalized polymer has a number average molecular weight of about 25 kDa to about 400 kDa.

Aspect 48. The method of aspect 46 or aspect 47, wherein the aliphatic polyester has a number average molecular weight of about 5 kDa to about 100 kDa.

Aspect 49. The method of any one of aspects 46-48, wherein the graft polymer has a number average molecular weight of 400 kDa to about 3500 kDa.

Aspect 50. The method of any one of aspects 46-49, wherein the aliphatic polyester or aliphatic polyester derivative is poly(lactic acid) or a derivative thereof.

Aspect 51. The method of any one of aspects 46-50, wherein the azide salt is sodium azide.

From the foregoing, it will be seen that aspects herein are well adapted to attain all the ends and objects hereinabove set forth together with other advantages which are obvious and which are inherent to the structure.

While specific elements and steps are discussed in connection to one another, it is understood that any element and/or steps provided herein is contemplated as being combinable with any other elements and/or steps regardless of explicit provision of the same while still being within the scope provided herein.

It will be understood that certain features and subcombinations are of utility and may be employed without reference to other features and subcombinations. This is contemplated by and is within the scope of the claims.

Since many possible aspects may be made without departing from the scope thereof, it is to be understood that all matter herein set forth or shown in the accompanying drawings and detailed description is to be interpreted as illustrative and not in a limiting sense.

It is also to be understood that the terminology used herein is for the purpose of describing particular aspects only, and is not intended to be limiting. The skilled artisan will recognize many variants and adaptations of the aspects described herein. These variants and adaptations are intended to be included in the teachings of this disclosure and to be encompassed by the claims herein.

Now having described the aspects of the present disclosure, in general, the following examples are put forth so as to provide those of ordinary skill in the art with a complete disclosure and description of how the compounds, compositions, and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure.

### EXAMPLES

Ever growing concerns over the introduction of petroleum-based plastic waste to and prevalence of microplastics in the environment fuels the need to replace such non-degradable materials. Coupled with recent bans on non-degradable plastics for grocery bags and other single-use applications, there is significant interest in developing renewably sourced and/or environmentally degradable (i.e., compostable) materials to substitute for synthetic plastics in society. Such sustainable materials include compostable polyesters sourced from petroleum feedstocks (i.e., poly(ε-caprolactone) (PCL), poly(butylene succinate) (PBS)), compostable polyesters sourced from renewable feedstocks (i.e., poly(lactic acid) (PLA), poly-3-hydroxybutyrate), or naturally occurring biopolymers (i.e., proteins, polysaccharides) and their derivatives (i.e. starch esters, cellulose esters) (Karan et al., 2019). However, the sustainable materials mentioned above tend to have higher production costs, lower toughness, in some cases inadequate melt processability, and higher water sensitivity versus traditional petroleum-sourced plastics, hindering their widespread use in applications such as single-use packaging (Muthuraj et al., 2017). A common approach to improve the cost effectiveness and range of physicochemical properties of polymers is through physical blending with another polymer that has complementary cost or properties desired for a given application. However, most pairs of polymers are thermodynamically immiscible, resulting in phase separation in polymer blends, causing poor physical properties arising from the lack of adhesion between phase-separated domains in the blended system (Utracki, 2002).

Introduction. Properties of immiscible polymer blends, including polysaccharide-based blends, can at times be improved by addition of a well-designed graft (co)polymer compatibilizer. These graft copolymers comprise two polymers, each miscible with one of the blend components, allowing the compatibilizer to sit at the interface of immiscible phases, reduce interfacial tension, enhance phase adhesion, and better stabilize the phase-separated morphology to improve physicochemical properties of the blend (Self et al., 2022). Blend compatibilization can optimally result in synergistic enhancements of properties including impact resistance (Mustafa et al., 2001) and tensile strength (Klimovica et al., 2020), generating blended systems with unique properties compared to their constituent components Possibly the most ubiquitous polymer blend compatibilized with a graft polymer is high-impact polystyrene (HIPS), which is a blend containing a glassy polystyrene (PS) matrix and dispersed rubbery polybutadiene (PBD) phases containing a PS-g-PBD graft polymer (Hobbs, 1986).

Some polysaccharide-based graft polymers, where the polysaccharide is the backbone and the other blend component comprises the grafted chains, have been previously studied as compatibilizers for immiscible blends. The plethora of hydroxy groups on each monosaccharide repeat unit are conducive to producing graft polymer structures, as these functionalities can act as initiating species for ring-opening polymerization (Saadatmand et al., 2011) (ROP) or can be substituted with initiating species for controlled radical polymerizations, such as atom transfer radical polymerization (ATRP) (Meng et al., 2009) or reversible addition-fragmentation chain transfer (RAFT) (Ott et al., 2016) polymerization. Due to the biodegradable nature of polysaccharides and the drive to generate compostable materials, significant research has been conducted on the synthesis of polyester-grafted polysaccharides (many aliphatic polyesters are also biodegradable) (Wang et al., 2024) and their applications as blend compatibilizers. Examples of such graft polymer compatibilizers include CTA-g-PLLA and CTA-g-PDLLA for CTA/PLLA blends (Volokhova et al., 2019), CA-g-PDLLA for CA/PLLA blends (Quintana et al., 2014), amylose-g-PDLLA for starch/PLA blends (Schwach et al., 2008), starch-g-PCL for starch/PCL blends (Lopez et al. 2019), and dextran-g-PCL for starch/PCL blends (Rutot et al. 2001). Other compatibilization strategies for polysaccharide-based blends include the addition of amphiphilic plasticizers (Yokesahachart & Yoksan, 2011), crosslinking agents such as benzoyl peroxide and maleic anhydride (Huneault & Li, 2007), and the addition of a third, distinct polymeric component, such as the addition of poly(vinyl acetate-co-vinyl alcohol) to TPS/PLLA blends (Ke & Sun, 2003) or the addition of a poly(butylene succinate) (PBS) based copolymer to wheat flour/PBS blends (Soccio et al., 2020). While these approaches proved able to compatibilize these immiscible polysaccharide-based blends, the methods employed do not exert significant structural control over the microstructure and morphology of the resulting blended systems. To understand the structure-property relationships between graft polymer topology and compatibilization efficacy in polysaccharide-based blends, regioselective chemistries must be employed to generate well-defined graft polymers with tunable microstructures.

Synthesis of polysaccharide-based graft polymers with regioselective substitution of polymeric side chains is difficult due to the presence of multiple, chemically non-equivalent hydroxy groups on each monosaccharide repeat unit, which possess low and comparable reactivities (Fox et al., 2011). Despite this, various regioselective protecting groups and chemoselective methods have been employed to generate such well-defined structures. The Tsujii group prepared regioselectively substituted 2,3-di-O-methyl-6-polystyrene (PS) cellulose via regioselective tritylation of the C6 position, followed by permethylation, deprotection, and N-(3-dimethylaminopropyl)-N′-ethylcarbodiimide hydrochloride (EDC HCl) coupling of the deprotected C6-OH with 4-pentynoic acid. Subsequent CuAAC with an azide-terminated PS generated a regioselectively-substituted cellulosic bottlebrush polymer, which was studied via small-angle X-ray scattering (SAXS) and SEC-multi-angle light scattering (MALS) to study its conformation in solution (Kinose et al., Macromolecules, 2019). A similar approach was used to generate 2,3-di-O-PCL-6-PS (Sakakibara et al., 2021) and 2,3-di-O-poly(ethylene glycol) (PEG)-6-PS (Kinose et al., 2022) cellulosic bottlebrush polymers, which were used as materials to study solution dynamics and microphase separation of Janus bottlebrushes, respectively.

Regioselectively substituted polysaccharide graft copolymers can also be prepared by grafting-from methods, as demonstrated by Ifuku and Kadla, in which the authors prepared a 2,3-di-O-methyl-6-O-bromoisobutyryl cellulose macroinitiator for ATRP with N-isopropylacrylamide (NIPAAm), generating a thermoresponsive 2,3-di-O-methyl-6-PNIPAAm cellulose graft copolymer (Ifuku & Kadla, 2008). In addition to cellulose, chitosan with polymer side chains grafted regioselectively at the C6 position (Maku§ ka & Gorochovceva, 2006) and regioselectively (and chemoselectively) at the C2 primary amine have been prepared through both grafting-from (Munro et al., 2009) and grafting-to (Bhattarai et al., 2005) approaches. While these synthetic methods produced polysaccharide graft copolymers with high degrees of structural control, time-consuming protection and deprotection steps were required to ensure regioselectivity.

The Edgar group recently reported synthesis of 2,3-O-acetyl-6-azido-6-deoxy (2,3Ac-6N₃) amylose with exclusive incorporation of the azide moiety at the C6 position and controllable DS(N₃) as precursors to well-defined graft polymers (Thompson & Edgar, 2024).

The authors used a small molecule, tert-butyl propargyl ether, as a proof-of-concept to demonstrate the ability to generate branched polymers with high control over branch density and location. Such methodology could be expanded to CuAAC grafting-to, using an alkyne-terminated polymer, creating a pathway to regioselectively-grafted polysaccharide-based copolymers. This would permit generation of polysaccharide derivatives with a degree of microstructural control that is unusual in polysaccharide chemistry and could be valuable in performing structure-property relationship studies. Previous researchers have observed that both graft length and graft density have significant effects on both the morphology and thermomechanical properties of compatibilized blends (Klimovica et al., 2020). In particular, such well-defined graft polymers could allow for a systematic study of the effect of topological features such as graft density and graft length on the ability of these graft polymers to compatibilize otherwise immiscible blends. A deeper understanding of such structure-property relationships is vital to improve the range of physicochemical properties afforded to compatibilized polysaccharide-based blends, leading to more useful materials sourced from renewable feedstocks.

Presented herein is regioselective synthesis and characterization of well-defined amylose acetate (AmAc)-g-PLA graft polymers via grafting-to copper-catalyzed azide-alkyne click reaction (CuAAC) with PLA chains exclusively incorporated at the C6 position without the use of any protecting groups. It is hypothesized that this approach can achieve near-perfect regioselectivity, with near complete control over vital parameters like graft length and frequency. By varying degree of substitution (DS) (N₃), degree of polymerization (DP) (PLA), and the stereochemistry of lactide repeat units (L- vs. D/L-), well-defined graft polymers can be generated where the graft density, length, and stereochemistry can all be carefully tuned. It was expected that these studies would provide guidance to effective graft copolymer compatibilizers for immiscible blends of high DS(Ac) starch acetate (StAc) and PLA, with graft copolymer topological control allowing structure-property relationship studies. A compatibilized blend of StAc/PLA could be optimized to generate a less-expensive PLA-based material, possibly increasing its appeal as a more viable replacement to nondegradable plastics.

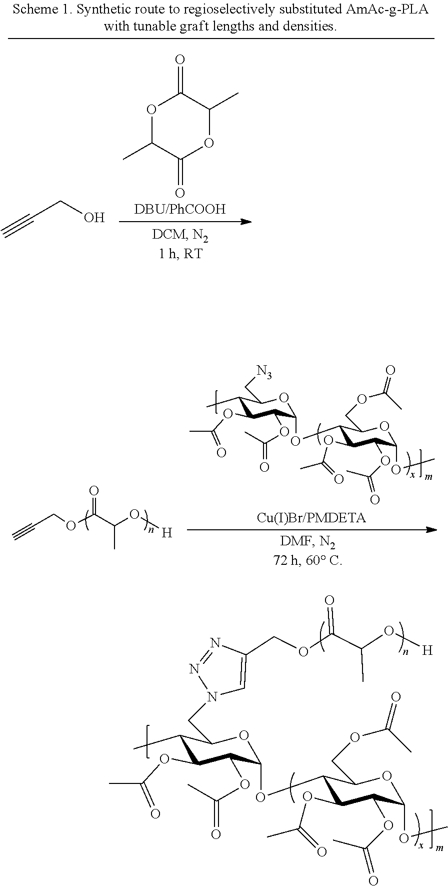

Experimental. Materials: Amylose isolated from potato starch (Biosynth, YA10257), with Mₙ=1610 kg/mol (DP=9940) and dispersity (Ð) equal to 4.12 (determined from size exclusion chromatography (SEC) of its tricarbanilate derivative (Evans et al., 1989)), and starch (isolated from potato, Sigma) were dried at 50° C. under reduced pressure overnight before use. N,N-Dimethylacetamide (DMAc, Fisher), dimethyl sulfoxide (DMSO, Sigma), pyridine (Sigma), and tin(II) 2-ethylhexanoate (SnOct₂, Sigma) were stored over 4 Å molecular sieves. Dichloromethane (DCM, Fisher) was dried over CaH₂, distilled onto 3 Å molecular sieves, and stored under dry N₂ until use. CHCl₃ (Fisher) was dried over P₂O₅, distilled onto 3 Å molecular sieves, and stored under dry N₂ until use. N,N-Dimethylformamide (DMF, Spectrum) and benzyl alcohol (BnOH, Sigma) were dried over CaH₂, distilled under reduced pressure onto 4 Å molecular sieves, and stored under dry N₂ until use. Propargyl alcohol (Sigma), N,N,N′,N″,N″-pentamethyldiethylenetriamine (PMDETA, Oakwood Chemical), and 1,8-diazabicyclo[5.4.0]undec-7-ene (DBU, Sigma) were dried over CaH₂, distilled under reduced pressure onto 3 Å molecular sieves, and stored under dry N₂ until use. LiBr (Alfa Aesar) and NaN₃ (Fisher) were dried overnight at 125° C. under reduced pressure and stored in a desiccator under vacuum until use. Benzoic acid (PhCOOH, Merck) was dried overnight at 80° C. under reduced pressure and stored in a desiccator under vacuum until use. Triphenylphosphine (PPh₃, Sigma) was recrystallized from ethanol (EtOH) and dried at room temperature (RT) under reduced pressure for 2 days. N-Bromosuccinimide (NBS, Acros) was recrystallized from boiling water and dried at RT over anhydrous CaCl₂ under reduced pressure for 2 days. L- and D,L-lactide (Chemlmpex) were recrystallized from ethyl acetate (EtOAc) and dried at RT under reduced pressure for 2 days. Copper(I) bromide (Sigma) was stored under dry N₂ until use. Acetic anhydride (Ac₂O, Acros), trifluoroacetic anhydride (TFAA, Sigma), acetic acid (AcOH, Fisher), phenyl isocyanate (Acros), sodium iodide (NaI, Fisher), Merrifield resin (α-chloromethylstyrene supported on crosslinked polystyrene, 2.0-3.0 mmol-Cl·g⁻¹, TCI), and Chelex 100 sodium form (sodium iminodiacetate supported on crosslinked polystyrene, 50-100 mesh, Sigma) were used as received. All other solvents and materials were of reagent grade and used as received.

Measurements: ¹H and ¹³C NMR spectra were obtained on either a Bruker Avance II 500 MHz spectrometer equipped with a BBO Prodigy probe at RT using deuterated chloroform (CDCl₃) as solvent. ¹H NMR spectra for alkyne-terminated PLA were obtained on an Agilent MR4DD2 400 MHz spectrometer with a broadband OneNMR probe. ¹H NMR spectra were obtained with at least 64 scans with 1 sec delay. ¹³C NMR spectra were obtained using at least 4096 scans with 3 sec delay. Diffusion-ordered spectroscopy (DOSY) experiments were performed using a Bruker Avance Ill 400 MHz/9.4 T wide-bore spectrometer equipped with a high gradient diffusion probe (Bruker Diff50) paired with a 5 mm ¹H RF coil inset. Self-diffusion coefficients of selected polymers were obtained using the pulse-gradient stimulated echo (PGSTE) experiment on ¹H nuclei at 25° C. The measurement used a 90° time of 4.5 μs, an acquisition time of 1 s, a repetition time of 2 s, δ=1-1.5 ms, Δ=30-50 ms, and a maximum gradient strength ranging from 300-900 G/cm. The values of these diffusion encoding parameters were selected to achieve 85% attenuation in 16 steps. Fourier transform infrared (FTIR) spectra were acquired using a Varian 670 IR spectrometer equipped with a Pike Technologies GladiATR attachment and collected as the average of 32 scans. Thermogravimetric analysis (TGA) was performed using a TA Instruments TGA 5500 at a heating rate of 20° C.·min⁻¹ up to 500° C. Glass transition temperatures (T_{g}s) were obtained by differential scanning calorimetry (DSC) performed on a TA Instruments DSC Q2500. Samples were heated at 10° C.·min⁻¹ up to approximately 30-50° C. below onset of decomposition, then cooled at 20° C.·min⁻¹ to 0° C., then heated again at 10° C.·min⁻¹. T_{g} values were obtained from the second heating cycle to erase any previous thermal history. SEC-MALS characterization of PLA was carried out in THF (stabilized with 1 mM BHT) at 1 mL·min⁻¹ at 30° C. using a Shimadzu LC-20AD HPLC pump equipped with an Agilent PLgel MIXED 10 μm guard column, two Agilent PLgel 10 μm MIXED-B LS separation columns, a Wyatt DAWN HELEOS-II MALS detector, and a Wyatt Optilab T-rEx dRI detector. All samples were weighed into a glass vial, dissolved in the mobile phase, then filtered through a 0.22 μm PTFE syringe filter. Absolute molecular weights and dispersities were calculated with Wyatt ASTRA software and off-line dn/dc analysis, assuming 100% mass recovery. SEC-MALS characterization of StAc was performed in DMAc with 50 mM LiCl at 50° C. at a flow rate of 0.5 mL/min (Agilent isocratic pump, degasser, and autosampler, columns: TOSOH TSKgel Guard Alpha and TOSOH TSKgel Alpha-3000: molecular weight range 0-1×10⁵ g/mol). Detection consisted of a Wyatt Optilab refractive index (RI) detector operating at 785 nm, a Wyatt DAWN multi-angle light scattering detector operating at 783 nm, and an Agilent MWD operating at 365 nm. Absolute molecular weights and dispersities were calculated using Wyatt ASTRA software and off-line dn/dc analysis, assuming 100% mass recovery. Films of 70/30 StAc/PDLLA blends with thickness below 10 μm, suitable for phase contrast optical microscopy (PCOM) and small-angle laser light scattering (SALLS), were prepared through solution casting. The polymer and compatibilizers were dissolved in CHCl₃ (1 wt/v %) at RT until clear solutions were obtained. Then, 0.03 mL of the solution was cast onto microscope slides and evaporated over 15 min was controlled by covering the cast solution with a 25 mL Erlenmeyer flask. PCOM was used to characterize the morphology of the blends. For this analysis, a Nikon Eclipse LV100 microscope in phase contrast mode equipped with an AmScope digital camera (MU503B) was used. The images were collected using a 20×Ph1 objective. Small-angle laser light scattering (SALLS) was used to measure blend interdomain distances. Scattering patterns were obtained in transmission with parallel polarizers (Vv mode) using a 3 mW He—Ne (λ=632.8 nm) laser font and a AmScope digital camera (MU503B). The scattering vector (q) range was calibrated using a 300 grooves/mm diffraction grating with a sample-to-detector distance of 24 cm. The radially integrated scattering intensity as a function of the scattering vector (q) was obtained using SAXSGUI software and the interdomain distance (d) at the maximum intensity was calculated. Calculations for determining the diffusion coefficient (D), interdomain distance (d), Fox-Flory parameters, and PLA degree of substitution (DS(PLA), i.e., graft density) are provided in the Supplementary Information.

Representative synthesis of 2,3-O-acetyl-6-azido-6-deoxy (2,3Ac-6N₃) amylose: Briefly, dry amylose (2.50 g, 15.4 mmol anhydroglucose units (AGU)) was slurried in 100 mL anhydrous DMAc at 160° C. for 30 min under N₂, after which 10.0 g dry LiBr was added to the flask followed by an additional 20 mL anhydrous DMAc. The mixture was stirred for an additional 10 min, after which approximately 20 mL DMAc was distilled under slight vacuum. The flask was backfilled with dry N₂ and allowed to cool to RT, resulting in a transparent, amber solution. All solutions were kept under dry N₂ until use within 24 h. Ac₂O (14.6 mL, 154 mmol, 10 eq/AGU) was added quickly to the flask under dry N₂ and allowed to mix at RT for 1 h. PPh₃ (4.04 g, 15.4 mmol, 1 eq/AGU) and NBS (2.74 g, 15.4 mmol, 1 eq/AGU) were dissolved in separate 50 mL portions of dry DMAc. The PPh₃ solution was added to the amylose solution over 5 min via syringe transfer, followed by the NBS solution, also over 5 min via syringe transfer, all under dry N₂. The flask was lowered into an oil bath set at 70° C. and allowed to stir at that temperature for 1 h. The temperature was then raised to 80° C., and the solution was stirred for an additional 32 h. The solution was added to 2.5 L chilled 1:1 H₂O:MeOH to precipitate the product, which was isolated by filtration. The product was twice dissolved in acetone/EtOAc and twice reprecipitated in EtOH, being collected by filtration each time. The resulting product was dried overnight at 50° C. under reduced pressure to yield 2,3-O-acetyl-6-bromo-6-deoxyamylose (2,3Ac-6Br amylose, DS(Ac) 2.88, DS(Br) 0.12). Dry 2,3Ac-6Br amylose (DS(Ac) 2.88, DS(Br) 0.12), 2.50 g, 8.64 mmol AGU) was dissolved in 100 mL dry DMSO overnight at 40° C. NaN₃ (1.40 g, 2.5 eq/AGU) was added to the flask, and the solution was heated to 80° C. and stirred at that temperature for 24 h. The product was then poured into 1.5 L chilled MeOH and isolated by filtration. The product was redissolved in acetone/EtOAc and reprecipitated into EtOH, filtered, collected, and dried overnight at 50° C. under reduced pressure to yield 2,3-O-acetyl-6-azido-6-deoxyamylose (2,3Ac-6N₃ amylose, DS(Ac) 2.88, DS(N₃) 0.12). 2,3Ac-6N₃ amyloses will be denoted as 2,3Ac-6N₃ amylose_{x/y}, where x=DS(Ac) and y=DS(N₃). Yield: 2.05 g (82.6%). ¹H NMR (500 MHz, CDCl₃): 1.94-2.01 (C2/C3 —O—COCH₃), 2.17 (C6 —O—COCH₃), 3.50-3.62 (C6 —CH₂—N₃), 3.85-5.37 (H1-H5), 4.22-4.53 (C6 —CH₂—O—COCH₃). ¹³C NMR (125 MHz, CDCl₃): 20.6-21.0 (C2/C3/C6 —O—COCH₃), 51.2 (C6 —CH₂—N₃), 62.2 (C6 —CH₂—OCOCH₃), 69.0-72.9 (C2-C5), 95.7 (C1), 169.6-170.8 (C2/C3/C6 —O—COCH₃).

Representative synthesis of alkyne-terminated PLA: To a flame-dried, N₂-flushed Schlenk flask equipped with a stir bar, D,L-lactide (2.50 g, 17.3 mmol, 100 eq) and activated 3 Å molecular sieves were added. The flask was then evacuated at 0.07 mbar for 2 h to remove trace water present, then backfilled with dry N₂. Anhydrous DCM (24.5 mL) and propargyl alcohol (10.0 μL, 0.173 mmol, 1 eq) were added to the flask under N₂ and allowed to stir for 2 h to further dry the solution. In a separate vial, DCM (1 mL), active 3 Å molecular sieves, DBU (22.3 μL, 0.147 mmol, 0.85 eq) and PhCOOH (6.4 mg, 0.026 mmol, 0.15 eq) were added and allowed to sit for 2 h to allow the sieves to remove any trace water present. Then, 500 μL of the catalyst solution was quickly added to the lactide solution under N₂ to initiate polymerization at RT. After 1 h, the flask was exposed to air and the reaction was quenched with AcOH. The polymer solution was added dropwise to 750 mL cold MeOH to precipitate the product. The final product was isolated by filtration and further washed with MeOH to yield a white solid (M_{n,SEC}=15.4 kg·mol⁻¹, Ð=1.07). Entry PDLLA-15.4 k, Table 1. Yield: 2.14 g (85.6%). ¹H NMR (400 MHz, CDCl₃): 1.54 (terminal —CH₃), 1.58 (repeat unit —CH₃), 2.49 (—O—CH₂—C≡C—H), 4.35 (terminal —CH—), 4.72 (—O—CH₂—C≡C—H), 5.15 (repeat unit —CH—).

Representative synthesis of AmAc-g-PLA: In a 25 mL Schlenk flask, 2,3Ac-6N₃ amylose (DS(Ac) 2.88, DS(N₃) 0.12, 40 mg, 0.139 mmol AGU, 0.017 mmol —N₃) and PDLLA-15.4 k (387 mg, 0.025 mmol, 1.5 mol eq per mol AmAc C6-N₃) were dissolved in 10.425 mL anhydrous DMF. After dissolution, the polymer solution was sparged with dry N₂ for 30 min. In a 1-dram vial equipped with a rubber septum, Cu(I)Br (14.4 mg, 0.100 mmol, 6 eq per mol AmAc C6-N₃) and PMDETA (41.9 μL, 0.201 mmol, 2.0 eq per mol Cu(I)Br, 6 eq per mol —N₃) were dissolved in 1 mL anhydrous DMF and subsequently sparged with dry N₂ for 10 min. After both solutions were de-gassed, 250 μL of the catalyst/ligand solution was added to the polymer solution under N₂ through a N₂-purged needle. The flask was then lowered into an oil bath set at 60° C. and allowed to stir at that temperature for 72 h. PS—N₃ resin (500 mg, ˜1.00 mmol —N₃, ˜40 eq per mol alkyne-PDLLA) was quickly added to the flask under dry N₂, and the flask was subsequently sparged again with dry N₂ for 10 min. The flask was then allowed to stir at 60° C. for another 72 h to allow unreacted alkyne-PDLLA to conjugate to the PS resin.

Finally, the solution was exposed to air and filtered into a scintillation vial to remove the scavenging resin. Chelex resin was added to the vial and allowed to stir at RT for 1 d, with additional Chelex resin added until the solution turned colorless. The solution was diluted with EtOAc/DMF, filtered into a flask, concentrated via rotary evaporation, then added to EtOH to precipitate the product. The product was filtered, collected, redissolved in minimal CHCl₃, then added to 1:1 EtOH:hexanes to precipitate the product. The product was filtered and further washed with EtOH and hexanes, collected, and dried overnight at 50° C. under reduced pressure. AmAc-g-PLA graft polymers are be denoted with the convention of AmAcₓ-g_{y}-PLA-zk, where x is DS(Ac), y is DS(PLA) (i.e., grafting density), and z is the Mₙ of PLA in kg/mol obtained by SEC in THF. Yield: 137 mg (45.9%). ¹H NMR (500 MHz, CDCl₃) 1.54-1.58 (PLA —CH₃), 1.94-2.01 (AmAc C2/C3 —O—COCH₃), 2.20 (AmAc C6 —O—COCH₃), 3.54-5.38 (AmAc backbone), 4.22-4.53 (AmAc C6 —CH₂—O—COCH₃), 7.79 (triazole —N—CH≡C—). ¹³C NMR (125 MHz, CDCl₃) 16.7 (PLA —CH₃), 16.8 (terminal PLA —CH₃), 20.7-21.1 (AmAc C2/C3/C6 —O—COCH₃), 50.1 (AmAc C6 —CH₂—N—), 58.6 (PLA —C—CH₂—O—(COCHCH₃O)ₙ—), 62.4 (AmAc C6 —CH₂—OCOCH₃), 66.8 (terminal PLA —CH—OH), 69.0-73.0 (AmAc C2-C5 —CH—), 69.1 (PLA —CH—), 95.7 (AmAc C1 —CH—), 126.3 (triazole —N—CH═C—), 141.9 (triazole —N—CH═C—), 169.5-169.8 (PLA —O—COCH—), 169.6-170.8 (C2/C3/C6 —O—COCH₃).

Bulk ROP of D,L-lactide: To a flame-dried, N₂-flushed 100 mL 2-neck round bottom flask equipped with a magnetic stir bar and glass stopcock, D,L-lactide (20.0 g, 139 mmol, 700 eq) was added. The flask was evacuated under vacuum (0.07 mbar, 30 min) and backfilled with dry N₂ three times. To the flask was added a 5.00 M solution of BnOH in toluene (0.198 mmol, 1 eq) and a 0.752 M solution of SnOct₂ in toluene (0.139 mmol, 0.7 eq, 0.1 mol % of monomer) under dry N₂. The flask was lowered into an oil bath set at 160° C. and allowed to stir for 40 min, after which the temperature was increased to 180° C. and the melt was allowed to stir for an additional 20 min. The flask was then removed from heat, the contents diluted with CHCl₃, and the solution was poured into chilled MeOH to precipitate the product. The product was isolated by filtration and dried overnight at 50° C. under reduced pressure. Yield: 19.21 g (96.1%). ¹H NMR (400 MHz, CDCl₃) 1.58 (repeat unit —CH₃), 4.49 (benzyl —CH₂—) 5.15 (repeat unit —CH—), 7.16-7.37 (benzyl —CH).

Synthesis of StAc: In a 3-neck round bottom flask equipped with a mechanical stirrer, reflux condenser, and liquid addition funnel, dry starch (10.0 g, 61.7 mmol AGU) was slurried in AcOH (31.7 mL, 555 mmol, 9.00 eq/AGU) at 110° C. for 2 h. The slurry was allowed to cool to RT, after which TFAA (55.8 mL, 401 mmol, 6.50 eq/AGU) was added dropwise over 1 h via a liquid addition funnel. After all TFAA was added, the solution was heated to 70° C., where the light, opaque slurry slowly turned into a viscous, dark brown solution. After 1.5 h, the solution was cooled to RT, diluted with acetone, and added to 1.8 L cold MeOH to precipitate the product. The product was filtered, washed with H₂O and additional MeOH, and collected. The product was suspended in acetone, added to 1:1 H₂O:MeOH, filtered, collected, and dried overnight at reduced pressure at 50° C. Yield: 17.02 g (96.6%). ¹H NMR (500 MHz, CDCl₃) 1.95-1.99 (C2/C3 —O—COCH₃), 2.19 (C6 —O—COCH₃), 3.93-5.37 (H1-H6/6′). ¹³C NMR (125 MHz, CDCl₃) 20.7-21.0 (C2/C3/C6 —O—COCH₃), 62.3 (C6), 69.0-73.0 (C2-C5), 95.7 (C1), 169.6-170.9 (C2/C3/C6 —O—COCH₃).

Results and Discussion. Preparation of 2,3Ac-6N₃ amylose with varying DS(N₃): tuning graft density. The Edgar group recently reported regioselective synthesis of 2,3Ac-6N₃ amylose with N₃ density (DS(N₃)) of 0.04-0.99 as a functionalized backbone suitable for CuAAC modification (Thompson & Edgar, 2024). Due to the high degree of structural control over both azide-functionalization density and functionalization position (incorporated only at the C6 position, ensuring stoichiometric control up to a maximum of only 1 azide moiety per monosaccharide repeat unit), 2,3Ac-6N₃ amylose is an ideal candidate for preparing polysaccharide-based graft polymers with varying and tunable graft densities. Of particular interest for graft polymer compatibilizers are 2,3Ac-6N₃ amylose with DS(N₃) of 0.04, 0.12, and 0.19. Assuming full conversion of grafting-to CuAAC, these graft polymers have maximum grafting densities of 4%, 12%, and 19%. This corresponds to an AmAc backbone with PLA grafts occurring approximately every 20, 8, and 5 repeat units, respectively. The compatibilization efficacy of AmAc-g-PLA may improve with decreasing graft density, as this can allow for more favorable enthalpic interactions between the StAc phase (predominantly consisting of acetylated AGU repeat units) and ungrafted, AmAc repeat units (also consisting of acetylated AGU repeat units). As such, the focus herein was on preparing a library of AmAc-g-PLA graft copolymers with grafting densities <20%. Graft densities lower than 4% can be achieved through treating excess 2,3Ac-6N₃ amylose DS(Ac) 2.96/DS(N₃) 0.04 with alkyne-terminated PLA, meaning that some azide residues will remain unmodified, which will likely interfere with compatibilization results.

Preparation of alkyne-terminated PLA: tuning graft length. After preparation of the functionalized 2,3Ac-6N₃ amylose with varying DS(N₃), a series of PLAs end-functionalized with an alkynyl moiety were prepared as CuAAC partners for the grafting-to copolymer synthesis. The use of grafting-to chemistry allowed a high degree of control over both DP and Ð, as well as ready characterization thereof, allowing for a greater degree of control vs. grafting-from ROP. Also, the grafting-to method ensures that PLA grafts will only be appended at the C6 position of amylose, ensuring that maximally only one PLA graft could be incorporated at each monosaccharide.

Propargyl alcohol was used as initiator under anhydrous conditions to ensure that each PLA chain would contain a terminal alkynyl functionality suitable for CuAAC. PLA can be synthesized using a variety of organometallic or organic catalysts, with the predominant method being the bulk ROP catalyzed by tin(II) 2-ethylhexanoate (SnOct₂). Although previous studies have indicated that lactide ROP catalyzed SnOct₂ is living in nature and can generate PLA with high molecular weight (MW) and low dispersity (Watts et al., 2017), the possibility of intramolecular backbiting and transesterification could potentially result in products lacking alkyne termini, preventing CuAAC reactivity (Byers et al., 2017). Synthesis of ROP using SnOct₂ as catalyst is also typically conducted at high temperatures (˜180° C.), which raised concerns on whether full initiation with propargyl alcohol is possible due to its relatively lower boiling point (T_{b}=114° C.). Instead, 1,8-diazabicyclo[5.4.0]undec-7-ene (DBU) and benzoic acid (PhCOOH) were used as catalysts due to their high activity, fast kinetics at RT (permitting solution polymerization in dichloromethane (DCM)), low D, and low tendency for transesterification (Coady et al. 2011).

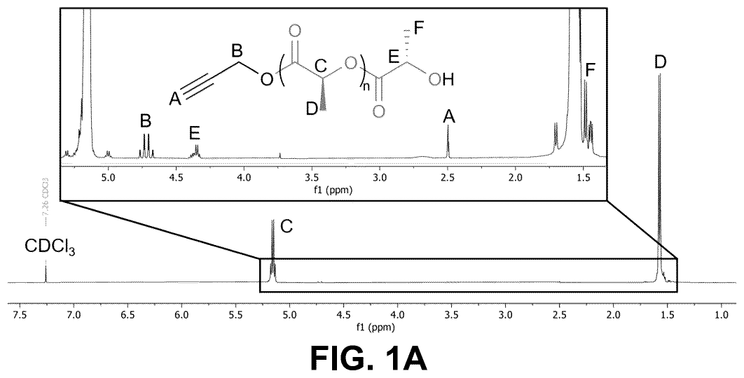

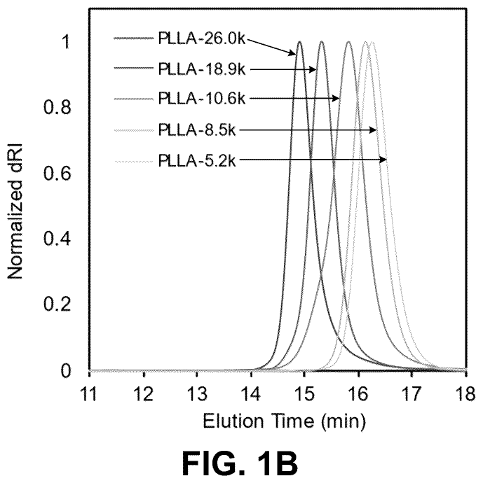

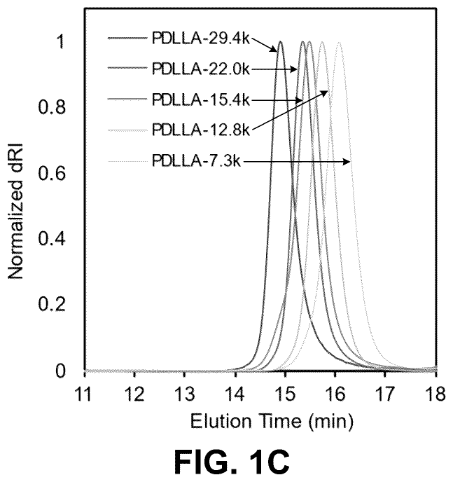

A series of alkyne-terminated PLAs with varying MW and tacticity were prepared (both racemic PDLLA and stereo-pure PLLA) through ROP of lactide initiated by propargyl alcohol using DBU/PhCOOH as a highly active organocatalyst pair. Successful synthesis of alkyne-terminated PLA was confirmed via ¹H NMR spectroscopy (FIG. 1A). Resonances associated with the PLA repeat unit methyl (D, 1.58 ppm), repeat unit methine (C, 5.15 ppm), terminal methyl (F, 1.54 ppm), and terminal methine (E, 4.35 ppm) were all readily identifiable and agreed with previous literature (Enomoto-Rogers & Iwata, 2012)). The terminal alkynyl functionality was confirmed by the characteristic triplet (A) at 2.49 ppm, indicating incorporation of the CuAAC reactive handle. Integral values of the alkyne methine (A), and terminal methine of the last lactyl repeat unit (E) ranged from 0.93:1.00 to 0.99:1.00, indicating that nearly all PLA chains were initiated by propargyl alcohol, rather than adventitious water that may have been present during polymerization. It should be noted that prevention of PLA initiation by water during ROP is difficult, even under anhydrous conditions (Volokhova et al., 2019).

In order to carefully tune the graft lengths of the final graft polymer by varying DP of the alkyne-terminated PLA, control over DP and dispersity was necessary. High control over DP allows for good control over the length of each PLA arm, while maintaining low Ð ensures that each arm is approximately the same length, which permits precise evaluation of structure-property relationships. Since PLA has a molecular weight for entanglement (Mₑ) of approximately 8.7 kg·mol⁻¹ (Dorgan et al. 1999), alkyne-terminated PLAs with molecular weights below, near, and above its Mₑ were prepared, as it is possible that increasing the graft length of PLA side chains past Mₑ would allow for entanglements between pendant side chains of AmAc-g-PLA and the PLA phase in StAc/PLA blends. As shown in FIG. 1B-1C and Table 1, a series of alkyne-terminated PLAs (both L- and D/L-) were prepared with Mₙ ranging from 5.2-29.4 kg/mol, all with narrow molecular weight distributions (Ð<1.10). Additionally, there was good agreement between Mₙ obtained from SEC and from ¹H NMR end-group analysis, further supporting that this approach affords good chain-end fidelity and negligible polymerization initiation from trace water.

TABLE 1
Results of ROP of L- and D-,L-lactide
with propargyl alcohol and DBU/PhCOOH.

| | Mₙ | Mₙ | | | |
|---|---|---|---|---|---|
| Sample | (¹H NMR, kg/mol) | (SEC, kg/mol) | Ð | I(A)/I(E) | T_{g} (° C.) |
| PLLA-5.2k | 4.8 | 5.2 | 1.03 | 0.98 | 48.1 |
| PLLA-8.5k | 8.8 | 8.5 | 1.09 | 0.93 | 50.5 |
| PLLA-10.6k | 9.4 | 10.6 | 1.09 | 0.96 | 51.9 |
| PLLA-18.9k | 18.5 | 18.9 | 1.03 | 0.99 | 53.7 |
| PLLA-26.0k | 23.9 | 26.0 | 1.02 | 0.98 | 55.8 |
| PDLLA-7.3k | 7.9 | 7.3 | 1.07 | 0.96 | 49.6 |
| PDLLA-12.8k | 12.3 | 12.8 | 1.08 | 0.93 | 51.4 |
| PDLLA-15.4k | 16.5 | 15.4 | 1.07 | 0.95 | 52.6 |
| PDLLA-22.0k | 18.8 | 22.0 | 1.02 | 0.98 | 52.9 |
| PDLLA-29.4k | 27.7 | 29.4 | 1.01 | 0.93 | 54.5 |

CuAAC of PLA and 2,3Ac-6N₃ amylose: tunable synthesis of AmAc-q-PLA. With functionalized AmAc backbone and alkyne-terminated PLA in hand, grafting-to was then performed to generate AmAc-g-PLA with varying graft density, graft length, and graft stereochemistry. These syntheses were performed under anaerobic conditions in anhydrous DMF using a slight excess of alkyne-terminated PLA per 6-N₃ moiety using a Cu(I)Br/PMDETA catalyst/ligand system. Initial attempts to synthesize 2,3Ac-6PLA amylose resulted in gelation, potentially due to the high concentration of final graft polymer in solution (˜150 mg/mL), causing formation of a physical gel. Subsequent grafting-to reactions were conducted at a total polymer concentration of 40 mg/mL and no gelation was observed.

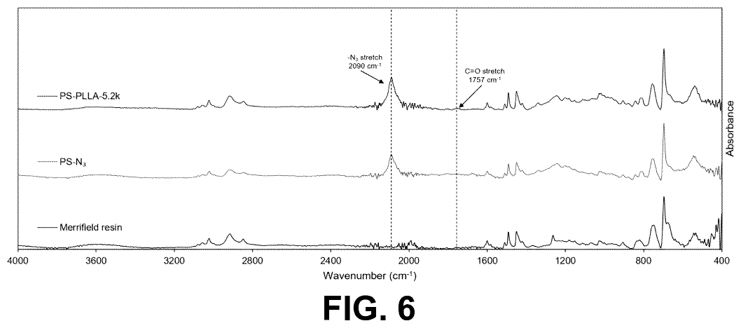

While formation of graft polymers via the grafting-to method allows for high degrees of control over the attached side chain, separation of the product from unreacted side chains (when used in excess relative to the polymer backbone) can be a challenge. Typically, PLA homopolymer can be separated from crude products of starch-g-PLA graft polymers via extraction with toluene (Chen et al., 2005; Chen et al., 2006) or acetone (Hu et al., 2013; Noivoil & Yoksan, 2020); however, the synthesized graft polymers discussed herein exhibited solubility in toluene (likely due to increased hydrophobicity as a result of acetyl substitution of hydroxyl groups), prohibiting this approach. Dialysis is effective at separating unreacted side chains from the desired graft polymer, but this method was both solvent and time intensive, and required a significant difference in MW between the graft polymer and un-grafted side chain (Gao & Matyjaszewski, 2007). Selective precipitation (in which the product mixture is added to a solvent which dissolves unreacted PLA but precipitates AmAc-g-PLA) was also not feasible due to the similar solubilities of PLA, 2,3Ac-6N₃ amylose, and AmAc-g-PLA. To circumvent the issues associated with the previous methods, a scavenging resin approach was used. After reacting alkyne-PLA and 2,3Ac-6N₃ under CuAAC conditions for 3 days, PS—N₃ resin was added to the flask, which was subsequently de-gassed again and run under CuAAC conditions for an additional 3 days. The excess, un-grafted PLA would react with the PS—N₃ resin, which could then easily be separated from the desired graft polymer by simple filtration. The appearance of carbonyl absorption bands in the FTIR spectra of scavenging resin indicated successful conjugation of alkyne-PLA to the PS beads (FIG. 6). The residual Cu(I) catalyst was removed by treating the AmAc-g-PLA solution with Chelex resin for 1 day under atmospheric conditions until the solution became transparent and colorless. Subsequent dilution with EtOAc, filtration, rotary evaporation, and precipitation into EtOH generated a white powder product.

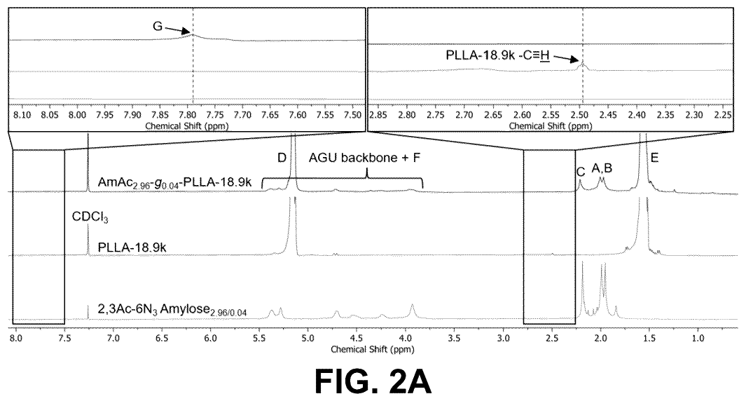

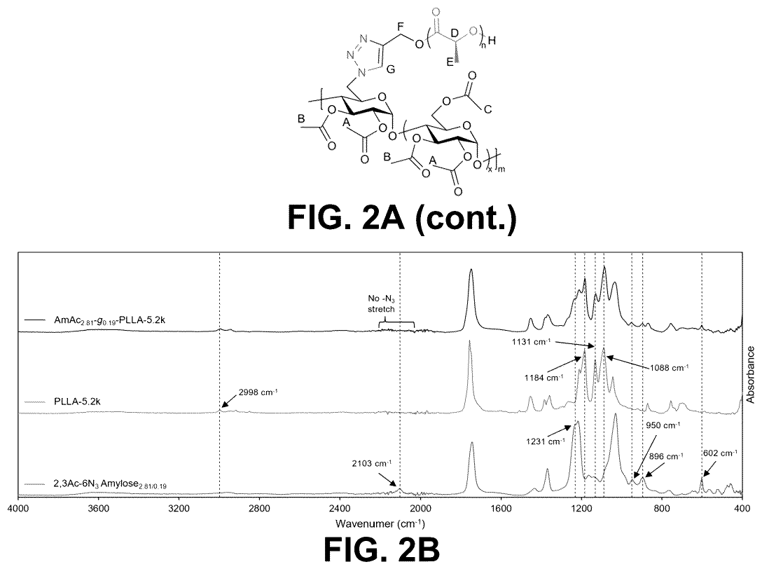

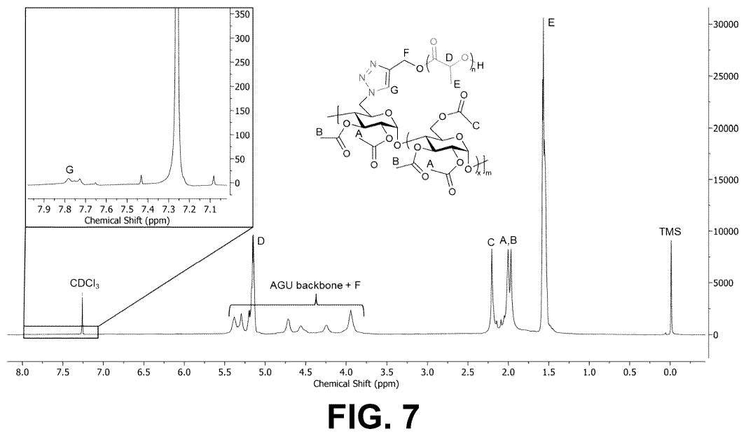

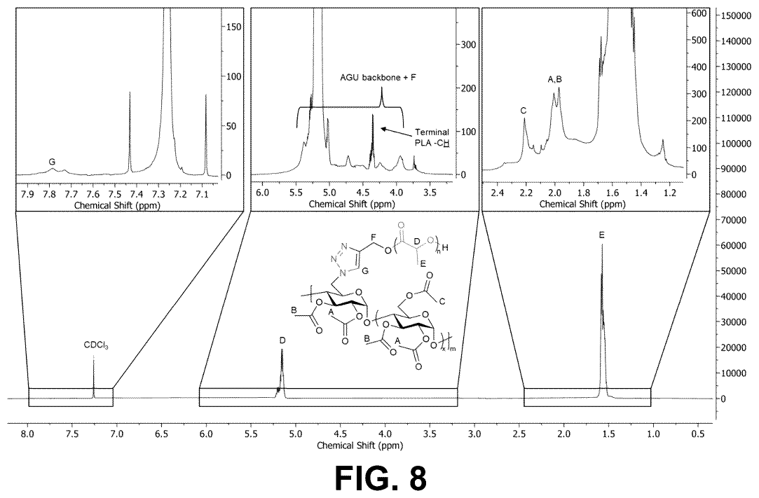

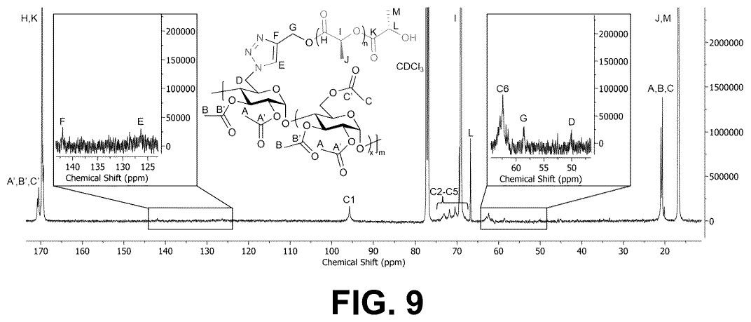

Successful grafting-to CuAAC was confirmed by ¹H NMR and FTIR spectroscopy. FIG. 2A shows the stacked ¹H NMR spectra of 2,3Ac-6N₃ amylose_{2.96/0.04}, PLLA-18.9 k, and AmAc_{2.86}-g_{0.04}-PLLA-18.9 k. The terminal alkyne PLA methine resonance at 2.49 ppm disappeared after CuAAC, along with the formation of a new triazole methine resonance at 7.79 ppm, supporting successful cycloaddition. Characteristic resonances associated with the AmAc AGU backbone (3.92-5.27 ppm), AmAc acetyl methyl groups (1.95-2.18 ppm), PLA repeat unit methyl groups (1.58 ppm), and PLA repeat unit methine groups (5.15 ppm) all were apparent in the product spectrum. The presence of these resonances, as well as the disappearance of the terminal alkyne methine and appearance of triazole methine resonances indicate that alkyne-PLA was successfully conjugated to 2,3Ac-6N₃ amylose via grafting-to CuAAC and was consistent for other graft copolymer samples (FIG. 7 and FIG. 8). DS calculations also indicated that grafting-to CuAAC went to full conversion when an excess of alkyne-terminated PLA was used, while lower DS(PLA) could be targeted by having the azide moiety present in excess relative to the alkyne. This permitted generation of AmAc_{2.86}-g-PDLLA graft copolymers with DS(PLA) 0.01 and 0.005, which are expected to be effective blend compatibilizers due to the lower graft density. ¹³C NMR further supported successful CuAAC linking alkyne-terminated PLA and azide-functionalized 2,3Ac-6N₃ amylose, with resonances associated with the AmAc C6-N— methylene (50.1 ppm), PLA initiator methylene (58.6 ppm), triazole methine (126.3 ppm), and triazole quaternary carbon (141.9 ppm) all readily identifiable (FIG. 9).

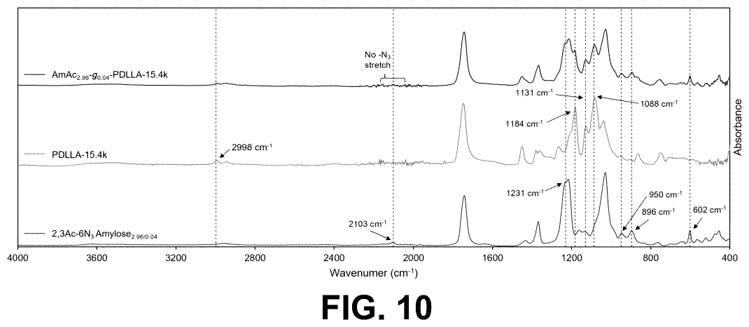

FTIR spectroscopy also supported successful grafting-to CuAAC, as the characteristic azide absorption band at 2103 cm⁻¹ present in 2,3Ac-6N₃ amylose was absent in the FTIR spectrum of AmAc-g-PLA, supporting complete cycloaddition to the corresponding triazole (FIG. 2B and FIG. 10). Absorption bands corresponding to PLA methine stretching (2998 cm⁻¹), AmAc C6-O-acetyl methylene asymmetric stretching (1231 cm⁻¹), PLA —CH—CO—O-asymmetric stretching (1184 cm⁻¹), PLA methyl asymmetric rocking (1131 cm⁻¹), PLA —O—CH—CO— asymmetric stretching (1088 cm⁻¹), AmAc acetal symmetric stretching (950 and 896 cm⁻¹) and AmAc C6-O-acetyl methylene wagging (602 cm⁻¹) modes were all identified in the FTIR spectrum of AmAc_{2.81}-g_{0.19}-PLLA-5.2 k and agreed with previously identified FTIR absorptions for PLLA (Meaurio et al., 2006) and StAc (Cuenca et al., 2020).

Although spectroscopic methods fully supported successful synthesis of AmAc-g-PLA, a possible next step would be to confirm product purity, since complete separation of unreacted alkyne-terminated PLA could be a challenge even after treatment with a scavenging resin. Normally, incorporation of side chains by grafting-to synthesis can be confirmed through a decrease in retention time observed in SEC (Gao & Matyjaszewski, 2007), indicating an increase in hydrodynamic radius (r_{H}) and concomitant increase in MW. However, some of the 2,3Ac-6N₃ amyloses used as functionalized backbones have MW values exceeding the total exclusion range of the SEC columns (Thompson & Edgar, 2024). Although an increase in MW should be detected by MALS, this determination of MW assumes that there is no aggregation of graft copolymer in solution. As an alternative, graft copolymers were characterized through diffusion ordered spectroscopy (DOSY).

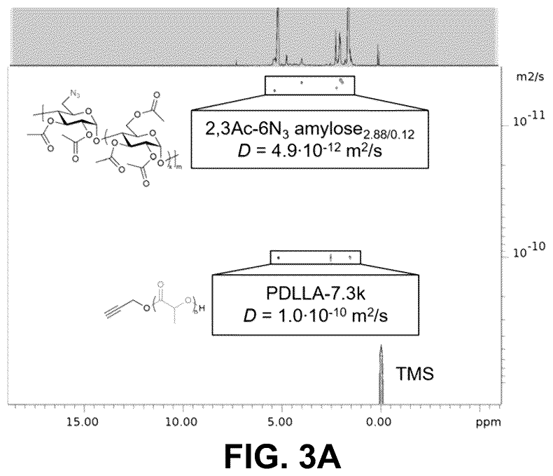

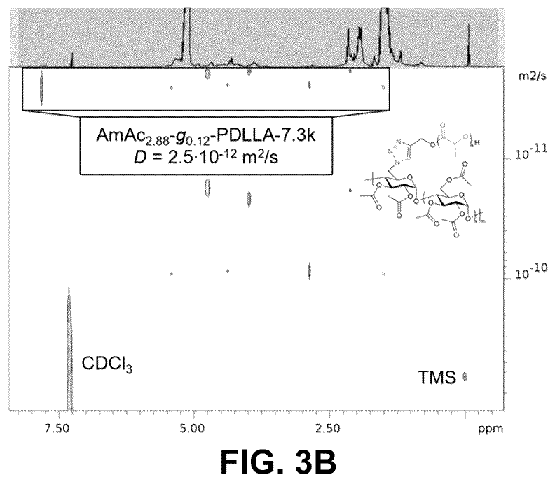

DOSY tracks the random diffusive motion of species in solution by monitoring the detected NMR signal as a function of gradient magnetic field strength to determine the diffusion coefficient (D) of a species in solution. DOSY has previously been employed to confirm synthesis of polymers with various topologies including block copolymers (Zhong et al., 2021), multi-reducing-end polysaccharides (Zhai et al., 2023), and polysaccharide graft copolymers (Moreira et al., 2015). Successful grafting-to CuAAC coupling would result in the appearance of a D slower than each individual graft copolymer component (indicating an increase in r_{H}), and each component would diffuse at the same rate (indicating covalent connection) (Coumes et al., 2013). As seen in FIG. 3A, there are two distinct D values observed corresponding to PDLLA-7.3 k (1.0·10⁻¹⁰ m²/s) and 2,3Ac-6N₃ amylose_{2.88/0.012} (4.9·10⁻¹² m²/s) when the two individual components are mixed in a common solvent. In FIG. 3B, after CuAAC of 2,3Ac-6N₃ amylose_{2.88/0.12} and PDLLA-7.3 k, there is a third, distinct D corresponding to AmAc_{2.88}-g_{0.12}-PDLLA-7.3 k (2.5·10⁻¹² m²/s) which is slower than either individual ungrafted backbone or side chain component. The PLA repeat unit methyl, AmAc acetyl methyl, AmAc AGU backbone, PLA repeat unit methine, and triazole methine diffuse at the same rate indicates that successful coupling was achieved. However, there are still signals corresponding to 2,3Ac-6N₃ amylose_{2.88/0.12} and PDLLA-7.3 k, indicating that CuAAC may not have reached full conversion and not all PDLLA-7.3 k was successfully removed by the scavenging resin, even though previous spectroscopic results indicate full grafting-to conversion and PLA removal. This may have resulted from partial oxidation of the Cu(I) catalyst to Cu(II), which is not catalytic for CuAAC (Hein & Fokin, 2010). Additionally, since partial initiation of ROP of lactide by trace water was observed, there will be some non-alkyne functionalized PLA introduced into the reaction mixture for CuAAC, which is non-reactive to CuAAC for both grafting-to and resin scavenging, which can also explain the incomplete removal of PLA. Although this observation was not intended, the presence of the distinct D for AmAc_{2.88}-g_{0.12}-PDLLA-7.3 k indicates successful grafting-to CuAAC.

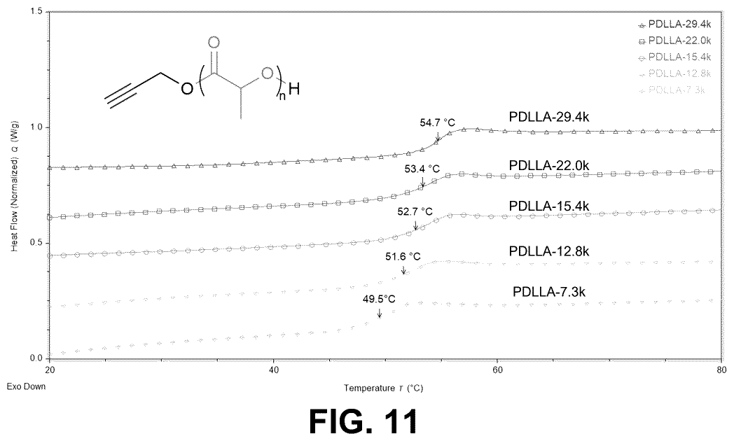

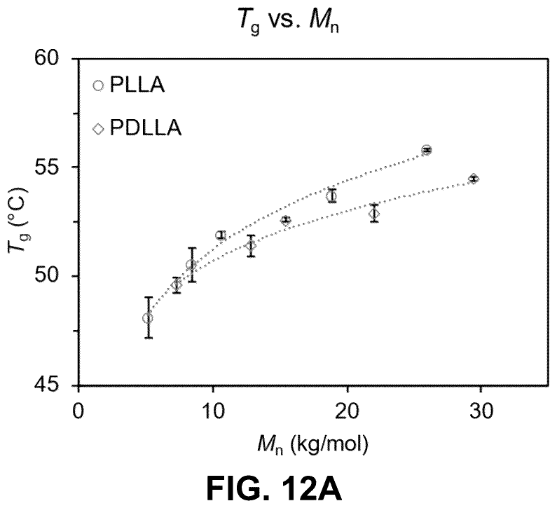

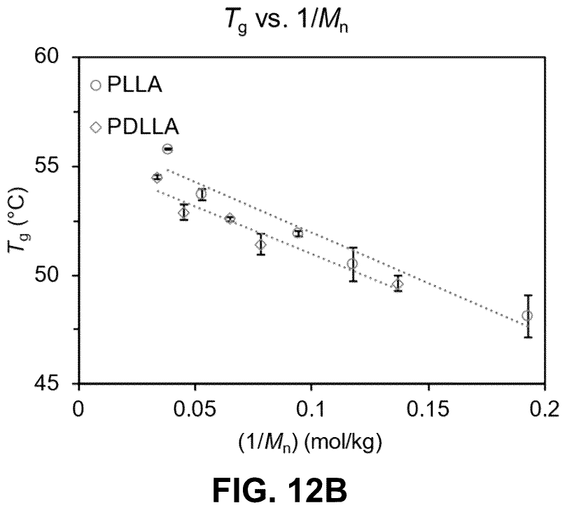

Thermal properties of amylose graft polymers. The impact of covalent conjugation of PLA to AmAc on thermal properties was investigated using differential scanning calorimetry (DSC). The T_{g} of alkyne-terminated PDLLA ranged from 50-55° C. and the T_{g} of alkyne-terminated PLLA ranged from 48-56° C., with alkyne-terminated PLLA exhibiting melting endotherms from 142-151° C. DSC thermograms of semicrystalline PLLA samples exhibited a bimodal melting endotherm commonly observed for PLLA and can been attributed to melt-recrystallization (Yasuniwa et al., 2004; He et al., 2007). The results for the relationship between Mₙ and T_{g} of both PLA isomers follow a Fox-Flory relationship, with extrapolated values of T_{g,∞} of 55° C. and 57° C. for PDLLA and PLLA, respectively, which is in agreement with previous literature results (FIG. 11 and FIG. 12 and Table 2) (Jamshidi et al., 1988; Zhang et al., 2022). Although PDLLA and PLLA are isomeric, the higher T_{g,∞} of PLLA can be rationalized by considering the effects of crystallinity on available free volume. Since the Fox-Flory relationship suggests that chain ends contribute significantly more to available free volume than interior repeat units, T_{g} increases with increasing Mₙ, as there will be fewer end groups relative to repeat units. Coupled with the fact that PLLA is semicrystalline while PDLLA is amorphous, it can be rationalized that some PLLA crystallites will contain chain ends, which negate this increase in free volume afforded to T_{g}(since the T_{g} is only experienced by the amorphous phase).

TABLE 2
Experimentally-determined Fox-Flory
parameters of PLLA and PDLLA

| Polymer | T_{g, ∞} (° C.) | K (kg/mol) |
|---|---|---|
| PLLA | 56.7 | 46.8 |
| PDLLA | 55.3 | 43.8 |

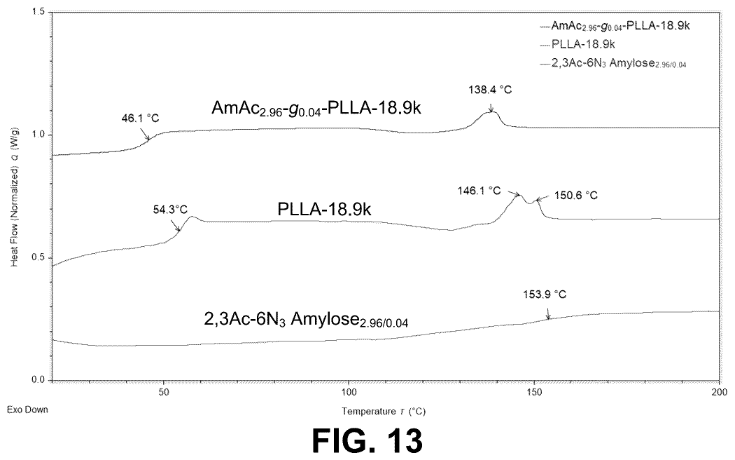

Grafting PLA to 2,3Ac-6N₃ amylose by CuAAC significantly impacted its thermal behavior. As seen in FIG. 4A, the T_{g} of PLLA side chains in AmAc_{2.88}-g_{0.12}-PLLA-10.6 k decreased from 52° C. to 48° C. while the Tₘ decreased from 148° C. to 136° C. for grafted and ungrafted side chains, respectively. PLLA grafts of AmAc_{2.86}-g_{0.04}-PLLA-18.9 k also exhibited a reduction of T_{g} and Tₘ compared to its ungrafted counterparts (FIG. 13). A similar depression of side chain Tₘ compared to ungrafted homopolymer was reported for CTA-g-PLLA (Volokhova et al., 2019) and ethyl cellulose-g-poly(p-dioxanone) (Zhu et al., 2010). This melting point depression can be rationalized by the presence of the rigid AmAc branching points and increased local concentration of PLLA end groups, both of which may act as defects and prevent formation of larger crystallites that melt at higher temperatures. Similar results were also observed for PLLA star polymers, where both T_{g} and Tₘ were suppressed compared to linear PLLA (Zhao et al., 2002).

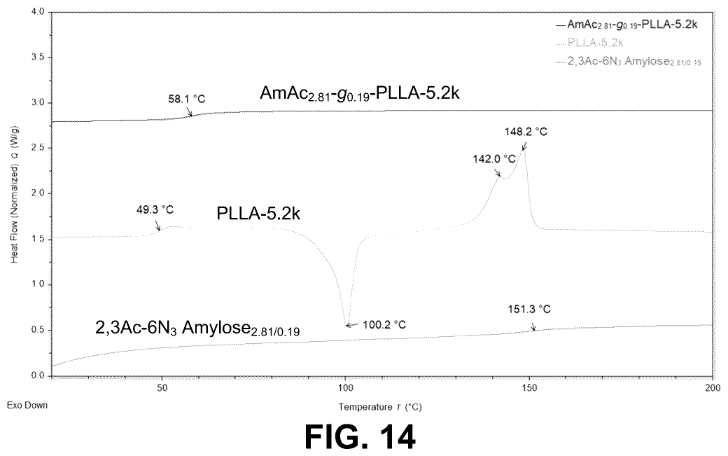

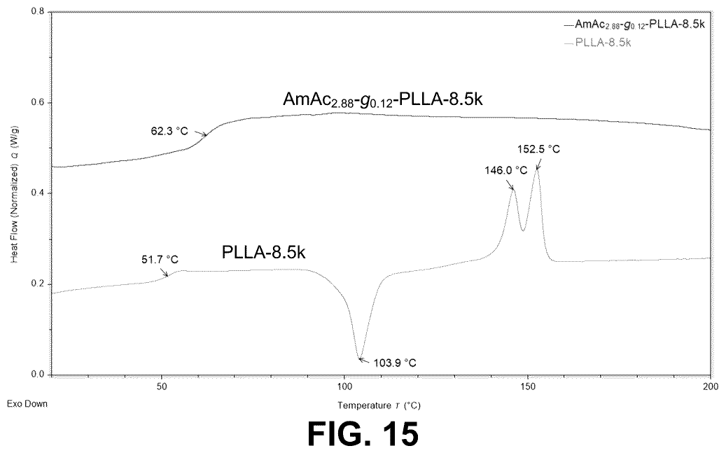

No PLLA melting endotherms were observed for AmAc_{2.81}-g_{0.19}-PLLA-5.2 k or AmAc_{2.88}-g_{0.12}-PLLA-8.5 k, suggesting that there may be a specific combination PLLA length and graft density required for grafted side chains to maintain crystallizability (FIG. 14 and FIG. 15), which is consistent with previous observations regarding cellulose esters grafted with polyhydroxyalkanoates (Teramoto et al., 2004). This could suggest that tethering crystallizable PLLA segments to the rigid AmAc backbone could impair PLLA molecular mobility enough to prevent generation of the regular packing structure necessary for crystallization. In the case where PLLA grafts did not exhibit melting endotherms, the T_{g} of PLLA segments increased from 49° C. to 58° C. and 52° C. to 63° C. for AmAc_{2.81}-g_{0.19}-PLLA-5.2 k or AmAc_{2.88}-g_{0.12}-PLLA-8.5 k, respectively, both of which exceed the calculated T_{g,∞} predicted by the Fox-Flory relationship. A similar PLLA graft crystallization inhibition and increase of PLLA T_{g} was observed for xylan-g-PLLA graft copolymers (Enomoto-Rogers & Iwata, 2012). Since one PLLA end group is tethered to the AmAc backbone, and polymer end groups contribute more to free volume than interior repeating units, the reduction in free volume afforded by a PLLA end group could cause T_{g} to increase.

As seen in FIG. 4B, T_{g} of PDLLA side chains of AmAc-g-PDLLA-29.4 k graft copolymers increased with decreasing graft density, with AmAc_{2.81}-g_{0.19}-PDLLA-29.4 k exhibiting a PDLLA T_{g} at 42° C. and AmAc_{2.96}-g_{0.005}-PDLLA-29.4 k exhibiting a PDLLA T_{g} at 52° C., with the highest PDLLA T_{g} of 57° C. for AmAc_{2.96}-g_{0.01}-PDLLA-29.4 k. PBD-g-PLLA (Leng et al., 2016) and poly(β-myrcene)-g-PLLA (Zhou et al., 2018) exhibited similar trends of decreasing PLA T_{g} with increasing graft density. While this may seem contradictory with previous results, there are multiple structural variables at play that dictate the molecular mobility of grafted side chains. Two competing factors contribute to the glass transition of polymer side chains in graft copolymers: the increase in free volume afforded by chain ends of polymer grafts, favoring T_{g} suppression, and the restriction of segmental mobility arising from covalent attachment to a polymer backbone, favoring T_{g} enhancement. Additionally, the flexibility of the graft copolymer backbone is affected by topological factors such as graft length and graft density (Morozova et al., 2018), which may in turn also change the T_{g} of grafted side chains. Additionally, the total weight fraction of PLA side chains compared to AmAc backbone will change with varying graft length and graft density, which may also have an effect on the thermal properties of the graft copolymer containing PLA arms connected to an AmAc backbone that are mutually immiscible (Table 3). These complex interrelationships between graft copolymer topology and thermal properties may warrant further investigation and could be valuable information for designing well-defined polysaccharide graft copolymers.

TABLE 3
Thermal properties of PLA grafts after grafting-to synthesis of AmAc-g-PLA

| | PLA T_{g, graft} | | | |
|---|---|---|---|---|
| Sample | (° C.) | ΔT_{g} (° C.) | PLA wt % | AmAc wt % |
| AmAc_{2.81}-g_{0.19}-PDLLA-29.4k | 41.7 | −12.8 | 94.9 | 5.1 |
| AmAc_{2.88}-g_{0.12}-PDLLA-29.4k | 43.1 | −11.4 | 92.3 | 7.7 |
| AmAc_{2.88}-g_{0.12}-PLLA-10.6k | 47.9 | −4.4 | 81.3 | 18.7 |
| AmAc_{2.96}-g_{0.04}-PDLLA-29.4k | 44.6 | −9.9 | 80.2 | 19.8 |
| AmAc_{2.88}-g_{0.12}-PLLA-8.5k | 62.3 | 10.6 | 77.7 | 22.3 |
| AmAc_{2.81}-g_{0.19}-PLLA-5.2k | 58.1 | 8.8 | 76.9 | 23.1 |
| AmAc_{2.96}-g_{0.04}-PLLA-18.9k | 46.1 | −8.2 | 72.3 | 27.7 |
| AmAc_{2.96}-g_{0.01}-PDLLA-29.4k | 56.8 | 2.3 | 50.5 | 49.5 |
| AmAc_{2.96}-g_{0.005}-PDLLA-29.4k | 51.5 | −3 | 33.8 | 66.2 |

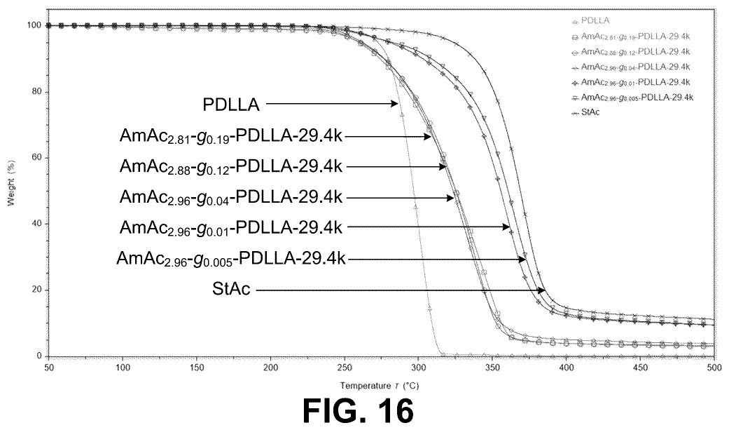

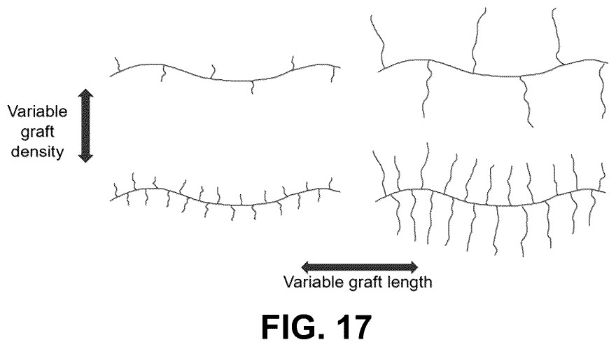

Surprisingly, there was no distinct T_{g} associated with the AmAc backbone of any AmAc-g-PLA graft copolymers investigated. The lower weight fraction of the AmAc backbone, coupled with the already broad glass transition exhibited by 2,3Ac-6N₃ amylose compared to that of PLA, may make the glass transition of the AmAc backbone difficult to observe. Previous polysaccharide graft copolymers also displayed difficult to detect polysaccharide backbone glass transitions (Volokhova et al., 2019; Enomoto-Rogers & Iwata, 2012). Thermal stability of AmAc-g-PDLLA graft copolymers, as measured by thermogravimetric analysis, was dependent on PDLLA grafting density. Pure PDLLA and StAc exhibited the onset of thermal degradation at 277° C. and 337° C., respectively. The thermal stability of AmAc-g-PDLLA-29.4 k increased with decreased grafting density, with AmAc_{2.81}-g_{0.19}-PDLLA-29.4 k and AmAc_{2.96}-g_{0.005}-PDLLA-29.4 k exhibiting thermal degradation beginning at 266° C. and 324° C., respectively (FIG. 16).

Initial investigation into AmAc-p-PDLLA as compatibilizer for StAc/PDLLA blends. Having successfully synthesized AmAc-g-PLA and determined the impact of polymer grafting on its thermal properties, the ability of AmAc-g-PLA to compatibilize immiscible blends of StAc and PLA was investigated. As both StAc (Fringant et al. 1998) and PLA (Yu et al. 2020) are biodegradable (under appropriate composting conditions) and are sourced from renewable starch feedstocks, blending them could create appealing sustainable materials. PLA possesses favorable physical properties similar to traditional commodity plastics such as polystyrene (PS) and poly(ethylene terephthalate) (PET) (T_{g}=45-65° C., Tₘ=150-200° C., 6=110 MPa, E=3.3 GPa), but is generally hindered by its high production cost relative to petroleum-based plastics (Taib et al. 2023). On the other hand, StAc is inexpensive but compromised by brittleness arising largely from its amylopectin content (Fringant et al. 1996). A compatibilized blend of StAc/PLA could be optimized to generate a less-expensive PLA-based material, possibly increasing its appeal as a more viable replacement to nondegradable plastics.

While compatibilized blends of PLA and thermoplastic starch (TPS) have been studied extensively (Villadiego et al., 2021), there is less precedent for studying StAc/PLA blends (Nasseri et al., 2020). A variety of factors affect the miscibility of StAc and PLA, including DS(Ac), MW of both polymers, stereochemistry of PLA, and potentially the amylose vs. amylopectin content of the StAc. A simplified test system was used for a proof-of-concept study to investigate the compatibilization ability of AmAc-g-PLA. The starch derivative was limited to a high DS(Ac) StAc, as this generated a polysaccharide derivative soluble in CHCl₃, which is a good solvent for PLA and is volatile enough for facile film casting. Film casting blends was more appealing for proof-of-concept studies than extrusion, as much less sample was required for analysis, although many starch/PLA blends studied in the literature are prepared through extrusion (Huneault & Li, 2007; Noivoil & Yoksan, 2020; Villadiego et al., 2021; Nasseri et al., 2020; Wang et al., 2007; Li & Huneault, 2010). Starch was treated with AcOH and TFAA to generate a peracetylated StAc with DS(Ac) of 2.94 and high MW (Mₙ=364 kg/mol, Ð=4.09 as determined by SEC in DMAc/LiCl). This method was adapted from an existing procedure (Yang & Montgomery, 2006) and relies upon the generation of the mixed acetic/trifluoroacetic acid anhydride in situ as the active acetylating agent (Scheme 2). While studying blends of both StAc/PLLA and StAc/PDLLA will be valuable, the initial investigation was limited to amorphous StAc/PDLLA blends to exclude the effects of crystallization from compatibilization. PDLLA (Mₙ=93.9 kg/mol, Ð=1.63) of comparable Mₙ and D to that of commercially available PLLA from Natureworks (Mₙ=85.7 kg/mol, Ð=1.69, as determined from SEC in THF) was synthesized through bulk ROP of D,L-lactide using BnOH as initiator and SnOct₂ as catalyst (Scheme 2).

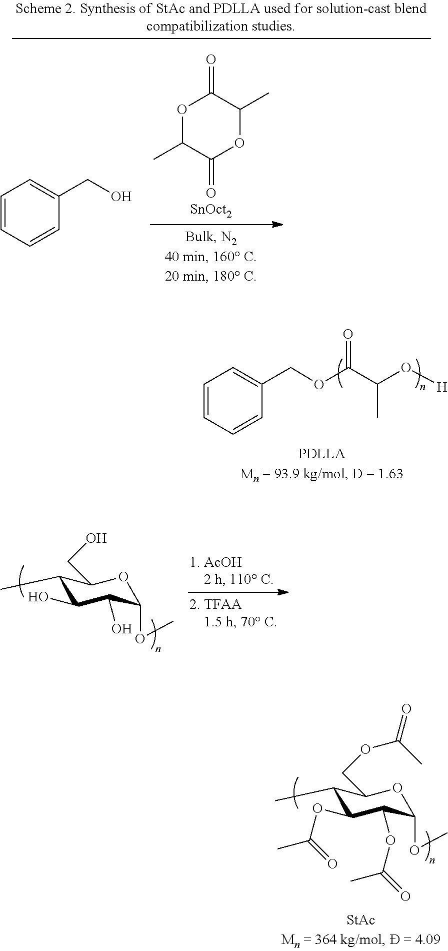

The desired amount of StAc and PDLLA was dissolved in CHCl₃, mixed the solutions, then drop-cast films on glass slides and let the solvent slowly evaporate. Blends with a composition of 70/30 StAc/PDLLA were chosen to study, as this generated blends with average interdomain spacing as determined by SALLS of 4.4±0.5 μm. Looking at the PCOM image in FIG. 5A, the phase separated morphology of the base blend exhibits a texture characteristic of spinodal decomposition, indicating thermodynamic immiscibility between StAc and PDLLA. In general, strong compatibilization is observed when interdomain spacings are below 1.0 μm, so the presence of uncompatibilized blends with domain sizes near 5.0 μm gave us a wide size range to observe the effects of AmAc-g-PDLLA on interdomain spacing.

For the initial investigation into the ability of AmAc-g-PDLLA graft copolymers to compatibilize immiscible blends, blends of 70/30 StAc/PDLLA containing 5 wt % of low graft density AmAc-g-PDLLA graft copolymers containing PDLLA-29.4 k side chains were prepared. As seen in FIGS. 5B-5C, both AmAc_{2.96}-g_{0.005}-PDLLA-29.4 k and AmAc_{2.96}-g_{0.01}-PDLLA-29.4 k graft copolymers (prepared through grafting-to CuAAC using 0.125 and 0.25 eq PDLLA per 2,3Ac-6N₃ amylose_{2.96}/0.04, respectively) reduced interdomain spacing to 2.8±0.5 μm and 3.0±0.4 μm, respectively. This reduction of domain size indicates that AmAc-g-PDLLA can reduce interfacial tension between immiscible StAc and PDLLA phases and stabilize the phase-separated morphology of StAc/PDLLA blends. With a library of AmAc-g-PDLLA graft copolymers with varying graft lengths and graft densities in hand, studies into the effect of graft copolymer topology on compatibilizer performance are underway and will be reported in a future study.

Conclusion. It has been demonstrated the ability to generate well-defined AmAc-g-PLA graft copolymers via grafting-to CuAAC with control over grafting position, length, density, and stereochemistry. T_{g} values of PLA side chains tended to increase after conjugation to the AmAc backbone, while AmAc-g-PLLA exhibited thermal transitions indicating a semicrystalline nature of PLLA grafts. AmAc-g-PDLLA graft polymers with grafting densities ranging from 0.1% to 19% and graft lengths ranging from 7.3-29.4 kg/mol were prepared as compatibilizers for immiscible StAc/PDLLA blends. Interdomain spacing in StAc/PDLLA blends, as observed through SALLS and PCOM, was observed to decrease with the addition of 5 wt % of AmAc-g-PDLLA, indicating the potential value of these graft copolymers as blend compatibilizers. An in-depth structure-property relationship study between AmAc-g-PDLLA topology and StAc/PDLLA blend morphology is currently underway. 201.

The synthesis procedures disclosed in the following paragraphs (regioselective chlorination of cellulose acetate and synthesis of (6-azido-6-deoxy)-co-(6-O-acetyl)-CA320S) are based at least in part on a previously published procedure (Gao et al., 2018).

Reqioselective chlorination of cellulose acetate (CA320S): In a 100 mL round-bottom (RB) flask CA320S (0.5 g, 2.1 mmol) was dissolved in 20 mL of anhydrous DMF at 75° C. MsCl (1.6 mL, 10 equiv. per AGU) was added dropwise to the solution. The reaction mixture was kept at 75° C. for 3 h under N₂ as the solution turned from colorless to yellow. It was slowly poured into 300 mL of deionized water, followed by filtration. The crude product was re-dissolved in acetone (5 mL) and re-precipitated in water (100 mL). The precipitate was recovered by filtration, washed extensively with water and ethanol, and vacuum dried overnight at 40° C. to yield (6-chloro-6-deoxy)-co-(6-O-acetyl)-CA320S (6-CICA320S). ¹³C NMR (500 MHz, DMSO-d6): 21.05 (Oe(C] O)—CH₃), 44.02 (Ce6eCl), 62.64 (Ce6′eOeAc), 71.74-79.91 (C2, C3, C4 and C5), 99.65 (C1), 103.43 (C1′), 161.30 (Oe(C]O)eH), 169.47-170.81 (Oe(C]O)eCH₃). EA: % C 46.16, % H 5.40, % Cl 7.28, % N 0.00, % S 0.58. DS calculated by EA: DS(Cl)=0.51. Maximum possible DS(Mesyl) calculated by EA (assuming all S comes from mesyl groups): DS(Ms)=0.04. Yield: 421 mg (81.0%).

Synthesis of (6-azido-6-deoxy)-co-(6-O-acetyl)-CA320S (6-N3CA320S): 6-CICA320S (200 mg, 0.82 mmol) was dissolved in 10 mL of anhydrous DMSO in a 100 mL RB flask, then NaN₃ (159 mg, 3 equiv. per AGU, 5.88 equiv. per Cl) was added to the flask. The reaction mixture was heated to 80° C. and stirred for 24 h under N₂. The solution was poured into 200 mL deionized water and the precipitate was collected by filtration. The product was washed with deionized water and ethanol before vacuum drying at 40° C., affording (6-azido-6-deoxy)-co-(6-O— acetyl)-CA320S (6-N₃CA320S). ¹³C NMR (500 MHz, DMSO-d6): 21.02 (Oe(C]O)eCH₃), 50.25 (Ce6eN₃), 62.59 (Ce6′eOeAc), 71.82-79.36 (C2, C3, C4 and C5), 99.61 (C1), 103.15 (C1′), 161.58 (Oe(C]O)eH), 169.43-170.77 (Oe(C]O)eCH₃). EA: % C 44.84, % H 5.09, % N 7.28, % Cl 0, % S 0.36. DS calculated by EA: DS(N₃) 0.44. Yield: 182 mg (90%).

### Additional Data: Calculations

$$DS ( PLA ) = \frac{I ( triazole - CH )}{I ( AmAc H 3 )} \qquad ( Equation 1 )$$

The degree of substitution of PLA (DS(PLA)) grafted to AmAc was calculated using Equation 1, where I(triazole —CH) is the integral value of the triazole formed after CuAAC (7.79 ppm) and I(AmAc H3) is the integral value of H3 of the AmAc AGU (5.37 ppm), obtained from ¹H NMR in CDCl₃.

$$I = {I}_{o} exp ( - D {γ}^{2} {g}^{2} {δ}^{2} Δ - \frac{δ}{3} ) \qquad ( Equation 2 )$$

Self-diffusion coefficients of selected polymers were obtained using the pulse-gradient stimulated echo (PGSTE) experiment on ¹H nuclei at 25° C. The Stejskal-Tanner equation (Equation 2) was used to fit the measured signal amplitude (l) as a function of gradient strength (g), where lₒ is the signal amplitude at g=0, γ is the gyromagnetic ratio of the measured nucleus, δ is the effective gradient pulse duration, Δ is the diffusion times between gradient pulses, and D is the self-diffusion coefficient (Stejskal & Tanner, 1965).

$${T}_{g} = {T}_{g , ∞} - \frac{K}{{M}_{n}} \qquad ( Equation 3 )$$

The relationship between number-average molecular weight (Mₙ) and the glass transition temperature (T_{g}) can be described by the Fox-Flory equation (Equation 3), where T_{g,∞} is the glass transition temperature at infinite molecular weight and K is a constant (Fox & Flory, 1950).

$$d = \frac{2 π}{q} \qquad ( Equation 4 )$$

The interdomain distance (d) of immiscible StAc/PDLLA blends was calculated by according to Equation 4, where q is the scattering vector and d is the interdomain distance at the maximum intensity.

Additional Data: Preparation of azide-functionalized polystyrene resin (PS—N). To an oven-dried 250 mL flask equipped with a magnetic stir bar, Merrifield resin (2.50 g, ˜6.25 mmol-Cl/g) was suspended in 125 mL anhydrous DMSO. NaI (4.06 g, 62.5 mmol, 10 eq) and NaN₃ (2.81 g, 18.8 mmol, 3 eq) were added to the flask and dissolved. The mixture was heated to 80° C. and stirred at that temperature for 48 h. The flask was then allowed to cool to RT, filtered, and rinsed with 1 L DI H₂O. The beads were then washed with a sequence of H₂O, acetone, CHCl₃, acetone, and H₂O to swell crosslinked PS and remove any residual salts present. The beads were then collected, air-dried, and dried under reduced pressure at 50° C. overnight.

### REFERENCES

References are cited herein throughout using the format of author last names and publication year enclosed by parentheses corresponding to one or more of the following numbered references. For example, citation of the first reference listed immediately herein below would be indicated in the disclosure as (Thompson & Edgar, 2024).
Thompson, J. E. & Edgar, K. J. “Regioselectivity and controlled-density branching in amylose esters.” Carbohydr. Polym., 2024, 332, 121885. DOI: 10.1016/j.carbpol.2024.121885.
Muthuraj, R.; Mirsa, M.; & Mohanty, A. K. Biodegradable compatibilized polymer blends for packaging applications: A literature review. J. Appl. Polym. Sci., 2017, 135 (24), 45726.
Utracki, L. A. Compatibilization of Polymer Blends. Can. J. Chem. Eng., 2002, 80 (6), 1008-1016.
Evans, R.; Wearn, R. H.; Wallis, A. F. A. Molecular Weight Distribution of Cellulose as its Tricarbanilate by High Performance Size Exclusion Chromatography. J. Appl. Polym. Sci., 1989, 37, 3291-3303.
Mustafa, S. J. S.; Azlan, M. R. N.; Fuad, M. Y. A.; Ishak, Z. A. M.; Ishiaku, U. S. Polypropylene/polystyrene blends —Preliminary studies for compatibilization by aromatic-grafted polypropylene. J. Appl. Polym. Sci., 2001, 82 (2), 428-434.
Meng, T.; Gao, X.; Zhang, J.; Yuan, J.; Zhang, Y.; He, J. Graft copolymers prepared by atom transfer radical polymerization (ATRP) from cellulose. Polymer, 2009, 50 (2), 447-454.
Ott, M. W.; Herbert, H.; Graf, M.; Biesalski, M. Cellulose-graft-polystyrene bottle-brush copolymers by homogeneous RAFT polymerization of soluble cellulose macro-CTAs and ‘CTA-shuttled’ R-group approach. Polymer, 2016, 98, 505-515.Wang, Y.; van Putten, R.-J.;
Tietema, A.; Parsons, J. R.; Gruter, G.-J. M. Polyester biodegradability: importance and potential for optimization. Green Chem., 2024, 26, 3698-3716.
Fox, S. C.; Li, B.; Xu, D.; Edgar, K. J. Regioselective Esterification and Etherification of Cellulose: A Review. Biomacromolecules, 2011, 12 (6), 1956-1972.
Watts, A.; Kurokawa, N.; Hillmyer, M. A. Strong, Resilient, and Sustainable Aliphatic Polyester Thermoplastic Elastomers. Biomacromolecules, 2017, 18 (6), 1845-1854.
Byers, J. A.; Biernesser, A. B.; Chiaie, K. R. D.; Kaur, A.; Kehl, J. A. Catalytic Systems for the Production of Poly(lactic acid). In: Di Loreno, M.; Androsch, R. (eds); Synthesis, Structure and Properties of Poly(lactic acid), 2017, 67-118.
Enomoto-Rogers, Y.; Iwata, T. Synthesis of xylan-graft-poly(L-Lactide) copolymers via click chemistry and their thermal properties. Carbohydr. Polym., 2012, 87, 1933-1940.
Chen, L.; Qiu, X.; Deng, M.; Hong, Z.; Luo, R.; Chen, X.; Jing, X. The starch grafted poly(L-lactide) and the physical properties of its blending composites. Polymer, 2005, 46 (15), 5723-5729.
Chen, L.; Qiu, X.; Xie, Z.; Hong, Z.; Sun, J.; Chen, X.; Jing, X. Poly(L-lactide)/starch blends compatibilized with poly(L-lactide)-g-starch copolymer. Carbohydr. Polym., 2006, 65 (1), 75-80.
Hu, Y.; Wang, Q.; Tang, M. Preparation and properties of Starch-g-PLA/poly(vinyl alcohol) composite film. Carbohydr. Polym., 2013, 96 (2), 384-388.
Noivoil, N.; Yoksan, R. Oligo(lactic acid)-grafted starch: A compatibilizer for poly(lactic acid)/thermoplastic starch blend. Int. J. Biol. Macromol., 2020, 160, 506-517.
Gao, H.; Matyjaszewski, K. Synthesis of Molecular Brushes by “Grafting onto” Method: Combination of ATRP and Click Reactions. J. Am. Chem. Soc., 2007, 129 (20), 6633-6639.
Meaurio, E.; López-Rodriguez, N.; Sarasua, J. R. Infrared Spectrum of Poly(L-lactide): Application to Crystallinity Studies. Macromolecules, 2006, 39, 9291-9301.
Cuenca, P.; Ferrero, S.; Albani, O. Preparation and characterization of cassava starch acetate with high substitution degree. Food Hydrocolloids, 2020, 100, 105430.
Zhong, Y.; Feng, Q.; Wang, X.; Yang, L.; Korovich, A. G.; Madsen, L. A.; Tong, R. Photocatalyst-independent photoredox ring-opening polymerization of O-carboxyanhydrides: stereocontrol and mechanism. Chem. Sci., 2021, 12, 3702-3712.
Zhai, Z.; Zhou, Y.; Korovich, A. G.; Hall, B. A.; Yoon, H. Y.; Yao, Y.; Zhang, J.; Bortner,
M. J.; Roman, M.; Madsen, L. A.; Edgar, K. J. Synthesis and Characterization of Multi-Reducing-End Polysaccharides. Biomacromolecules, 2023, 24 (6), 2596-2605.
Moreira, G.; Fedeli, E.; Ziarelli, F.; Capitani, D.; Mannina, L.; Charles, L.; Viel, S.; Gigmes, D.; Lefay, C. Synthesis of polystyrene-grafted cellulose acetate copolymers via nitroxide-mediated polymerization. Polym. Chem., 2015, 6, 5244-5253.
Coumes, F.; Darcos, V.; Domurado, D.; Li, S.; Courdane, J. Synthesis and ring-opening polymerisation of a new alkyne-functionalised glycolide towards biocompatible amphiphilic graft copolymers. Polym. Chem., 2013, 4,3705-3713.
Hein, J. E.; Fokin, V. V. Copper-catalyzed azide-alkyne cycloaddition (CuAAC) and beyond: new reactivity of copper(I) acetylides. Chem. Soc. Rev., 2010, 39, 1302-1315.
Yasuniwa, M.; Tsfubakihara, S.; Sugimoto, Y.; Nakafuku, C. Thermal analysis of the double-melting behavior of poly(L-lactic acid). J. Polym. Sci. Part B: Polym. Phys., 2004, 42 (1), 25-32.
He, Y.; Fan, Z.; Hu, Y.; Wu, T.; Wei, J.; Li, S. DSC analysis of isothermal melt-crystallization, glass transition and melting behavior of poly(L-lactide) with different molecular weights. Eur. Polym. J., 2007, 43 (10), 4431-4439.
Jamshidi, K.; Hyon, S.-H.; Ikada, Y. Thermal characterization of polylactides. Polymer, 1988, 29 (12), 2229-2234.
Zhang, R.; Du, F.; Jariyavidyanont, K.; Zhuravlev, E.; Schick, C.; Androsch, R. Glass transition temperature of poly(D,L-lactic acid) of different molar mass. Thermochim. Acta, 2022, 718, 179387.
Zhu, J.; Dong, X.-T.; Wang, X.-L.; Wang, Y.-Z. Preparation and properties of a novel biodegradable ethyl cellulose grafting copolymer with poly(p-dioxanone) side-chains. Carbohydr. Polym., 2010, 82 (2), 350-359.
Zhao, Y.-L.; Cai, Q.; Jiang, J.; Shuai, X.-T.; Bei, J.-Z.; Chen, C.-F.; Xi, F. Synthesis and thermal properties of novel star-shaped poly(L-lactide)s with starburst PAMAM-OH dendrimer macroinitiator. Polymer, 2002, 43 (22), 5819-5825.
Teramoto, Y.; Ama, S.; Higeshiro, T.; Nishio, Y. Cellulose Acetate-graft-Poly(hydroxyalkanoate)s: Synthesis and Dependence of the Thermal Properties on Copolymer Composition. Macromol. Chem. Phys., 2004, 205 (14), 1904-1915.
Leng, X.; Wei, Z.; Bian, Y.; Ren, Y.; Wang, Y.; Wang, Q.; Li, Y. Rheological properties and crystallization behavior of comb-like graft poly(L-lactide): influences of graft length and graft density. RSC Adv., 2016, 6, 30321-30329.
Zhou, C.; Wei, Z.; Wang, Y.; Yu, Y.; Leng, X.; Li, Y. Fully biobased thermoplastic elastomers: Synthesis of highly branched star comb poly(p-myrcene)-graft-poly(L-lactide) copolymers with tunable mechanical properties. Eur. Polym. J., 2018, 99, 477-484.
Morozova, S.; Schmidt, P. W.; Bates, F. S.; Lodge, T. P. Effect of Poly(ethylene glycol) Grafting Density on Methylcellulose Fibril Formation. Macromolecules, 2018, 51 (23), 9413-9421.
Villadiego, K. M.; Tapia, M. J. A.; Useche, J.; Macias, D. E. Thermoplastic Starch (TPS)/Polylactic Acid (PLA) Blending Methodologies: A Review. J. Polym. Environ., 2021, 30, 75-91.
Nasseri, R.; Ngunjiri, R.; Moresoli, C.; Yu, A.; Yuan, Z.; Xu, C. Poly(lactic acid)/acetylated starch blends: Effect of starch acetylation on the material properties. Carbohydr. Polym., 2020, 229, 115453.
Wang, N.; Yu, J.; Ma, X. Preparation and characterization of thermoplastic starch/PLA blends by one-step reactive extrusion. Polym. Int., 2007, 56 (11), 1440-1447.
Li, H.; Huneault, M. A. Comparison of sorbitol and glycerol as plasticizers for thermoplastic starch in TPS/PLA blends. J. Appl. Polym. Sci., 2010, 119 (4), 2439-2448.
Saadatmand, S.; Edlund, U.; & Albtersson, A. C. “Compatibilizers of a purposely designed graft copolymer for hydrolysate/PLLA blends.” Polymer, 2011, 52 (21), 4648-4655. DOI: 10.1016/j.polymer.2011.08.053.
Ifuku, S. & Kadla, J. F. “Preparation of a Thermosensitive Highly Regioselective Cellulose/N-Isopropylacrylamide Copolymer through Atom Transfer Radical Polymerization.” Biomacromolecules, 2008, 9 (11), 3308-3313. DOI: 10.1021/bm800911w.
Kinose, Y.; Sakakibara, K.; Ogawa, H.; & Tsujii, Y. “Main-Chain Stiffness of Cellulosic Bottlebrushes with Polystyrene Side Chains Introduced Regioselectively at the 0-6 Position.” Macromolecules, 2019, 52 (22), 8733-8740. DOI: 10.1021/acs.macromol.9b01628.
Sakakibara, K.; Ishida, H.; Kinose, Y.; & Tsujii, Y. “Regioselective synthesis of cellulosic janus bottlebrushes with polystyrene and poly (ε-caprolactone) side chains and their solid-state microphase separation.” Cellulose, 2021, 28, 6857-6868. DOI: 10.1007/s10570-021-03964-x.
Kinose, Y.; Sakakibara, K.; & Tsujii, Y. “Conformational characteristics of regioselectively PEG/PS-grafted cellulosic bottlebrushes in solution: cross-sectional structure and main-chain stiffness.” Polym. J., 2022, 54, 503-513. DOI: 10.1038/s41428-021-00594-9.
Makuška, R. & Gorochovceva, N. “Regioselective grafting of poly(ethylene glycol) onto chitosan through C-6 position of glucosamine units.” Carbohydr. Polym., 2006, 64, 319-327. DOI: 10.1016/j.carbpol.2005.12.006.
Munro, N. H.; Hanton, L. R.; Moratti, S. C.; & Robinson, B. H. “Synthesis and characterisation of chitosan-graft-poly(OEGMA) copolymers prepared by ATRP.” Carbohydr. Polym., 2009, 77, 496-505. DOI: 10.1016/j.carbpol.2009.01.026.
Bhattarai, N.; Matsen, F. A.; & Zhang, M. “PEG-Grafted Chitosan as an Injectable Thermoreversible Hydrogel.” Macromol. Biosci., 2005, 5 (2), 107-111. DOI: 10.1002/mabi.200400140.
Klimovica, K.; Pan, S.; Lin, T.; Peng, X.; Ellison, C. J.; LaPointe, A. M.; Bates, F. S.; & Coates, G. W. “Compatibilization of iPP/HDPE Blends with PE-g-iPP Graft Copolymers.” ACS Macro Lett., 2020, 9 (8), 11-61-1166. DOI: 10.1021/acsmacrolett.0c00339.
Volokhova, A. S.; Waugh, J. B.; Arrington, K. J.; & Matson, J. B. “Effects of graft polymer compatibilizers in blends of cellulose triacetate and poly(lactic acid).” Polym. Int., 2019, 68 (7), 1263-1270. DOI: 10.1002/pi.5820.
Self, J. L.; Zervoudakis, A. J.; Peng, X.; Lenart, W. R.; Macosko, C. W.; Ellison, C. J. “Linear, Graft, and Beyond: Multiblock Copolymers as Next-Generation Compatibilizers.” J. Am. Chem. Soc. Au, 2022, 2 (2), 310-321. DOI: 10.1021/jacsau.lc00500. 261. Quintana, R.; Persenaire, O.; Lemmouchi, Y.; Bonnaud, L.; & Dubois, P. “Grafted D/L-lactide to cellulose acetate by reactive melt processing: Its role as a CA/PLA blend compatibilizer.” Eur. Polym. J., 2014, 57, 30-36. DOI: 10.1016/j.eurpolymj.2014.05.003.
Ke, T. & Sun, X. S. “Starch, Poly(lactic acid), and Poly(vinyl alcohol) Blends.” J. Polym. Environ., 2003, 11 (1), DOI: 10.1023/A:1023875227450.
Soccio, M.; Dominici, F.; Quattrosoldi, S.; Luzi, F.; Munari, A.; Torre, L.; Lotti, N.; & Puglia, D. “PBS-Based Green Copolymer as an Efficient Compatibilizer in Thermoplastic Inedible Whear Flour/Poly(butylene succinate) Blends.” Biomacromolecules, 2020, 21, 3254-3269. DOI: 10.1021/acs.biomac.0c00701.
Yokesahachart, C.& Yoksan, R. “Effect of amphiphilic molecules on characteristics and tensile properties of thermoplastic starch and its blends with poly(lactic acid).” Carbohydr. Polym., 2011, 83, 22-31. DOI: 10.1016/j.carbpol.2010.07.020.
López, O. V.; Ninago, M. D.; Soledad Lencina, M. M.; Ciolino, A. E.; Villar, M. A.; & Andreucetti, N. A. “Starch/Poly(ε-caprolactone) Graft Copolymers Synthesized by γ-Radiation and Their Application as Compatibilizer in Polymer Blends.” J. Polym. Environ., 2019, 27, 2906-2914. DOI: 10.1007/s10924-019-01568-y.
Rutot, D.; Duquesne, E.; Ydens, I.; Degee, P.; & Dubois, P. “Aliphatic polyester-based biodegradable materials: new amphiphilic graft copolymers.” Polym. Degr. Stab., 2001, 73 (3), 561-566. DOI: 10.1016/S0141-3910(01)00142-2.
Schwach, E.; Six, J.; & Avérous, L. “Biodegradable Blends Based on Starch and Poly(Lactic Acid): Comparison of Different Strategies and Estimate of Compatibilization.” J. Polym. Environ., 2008, 16, 286-297. DOI: 10.1007/s10924-008-0107-6.
Huneault, M. A. & Li, H. “Morphology and properties of compatibilized polylactide/thermoplastic starch blends.” Polymer, 2007, 48 (1), 270-280. DOI: 10.1016/j.polymer.2006.11.023.
Yang, B. Y. & Montgomery, R. “Acylation of Starch using Trifluoroacetic Anhydride Promoter.” Starch, 2006, 58, 520-526. DOI: 10.1002/star.200600540.
Hobbs, S. Y. “The Effect of Rubber Particle Size on the Impact Properties of High Impact Polystyrene (HIPS) Blends.” Polym. Eng. Sci. 1986, 26 (1), 74-81. DOI: 10.1002/pen.76026011220.
Karan, H.; Funk, C.; Grabert, M.; Oey, M.; & Hankamer, B. “Green Bioplastics as Part of a Circular Economy.” Trends Plant Sci. 2019, 24 (3), 237-249. DOI: 10.1016/j.tplants.2018.11.010.
Dorgan, J. R.; Williams, J. S.; & Lewis, D. N. “Melt rheology of poly(lactic acid): Entanglement and chain architecture effects.” J. Rheol. 1999, 43 (5), 1141-1155. DOI: 10.1122/1.551041
Coady, D. J.; Fukushima, K.; Horn, H. W.; Rice, J. E.; & Hedrick, J. L. “Catalytic insights into acid/base conjugates: highly selective bifunctional catalysts for the ring-opening polymerization of lactide.” Chem. Commun. 2011, 47, 3105-3107. DOI: 10.1039/C0CC03987J.
Fringant, C.; Rinaudo, M.; Gontard, N.; Guilbert, S.; & Derradji, H. “A Biodegradable Starch Based Coating to Waterproof Hydrophilic Materials.” Starch. 1998, 50, 292-296. DOI: 10.1002/(SICI)1521-379X(199807)50:7<292::AID-STAR292>3.0.CO; 2-%23.
Yu, M.; Zheng, Y.; & Tian, J. “Study on the biodegradability of modified starch/polylactic acid (PLA) composite materials.” RSC Adv. 2020, 10, 26298-26307. DOI: 10.1039/DORA00274G.
Taib, N. A. A. B.; Rahman, M. R.; Huda, D.; Kuok, K. K.; Hamdan, S.; Bakri, M. K. B.; Julahi, M. R. M. B.; & Khan, A. “A review on poly lactic acid (PLA) as a biodegradable polymer.” Polym. Bull. 2023, 80, 1179-1213. DOI: 10.1007/s00289-022-04160-y.
Fringant, C.; Desbrières, J.; & Rinaudo, M. “Physical properties of acetylated starch-based materials: Relation with their molecular characteristics.” Polymer. 1996, 37 (13), 2663-2673. DOI: 10.1016/0032-3861(96)87626-9.
Gao, Chengzhe; Liu, Shu; Edgar, Kevin J. “Regioselective chlorination of cellulose esters by methanesulfonyl chloride.” Carbohydr. Polym., 2018, 193, 108-118. DOI: 10.1016/j.carbpol.2018.03.093.
Fox, T. G.; Flory, P. J. Second-Order Transition Temperatures and Related Properties of Polystyrene. I. Influence of Molecular Weight. J. Appl. Phys., 1950, 21, 581-591.
Stejskal, E. O.; Tanner, J. E. Spin Diffusion Measurements: Spin Echoes in the Presence of a Time-Dependent Field Gradient. J. Chem. Phys., 1965, 42 (1), 288-292.

It should be emphasized that the above-described embodiments of the present disclosure are merely possible examples of implementations set forth for a clear understanding of the principles of the disclosure. Many variations and modifications may be made to the above-described aspects. All such modifications and variations are intended to be included herein within the scope of this disclosure and protected by the following claims.

What is claimed:

1. A graft polymer, comprising a backbone polymer and at least one branch polymer attached to the backbone polymer, wherein the backbone polymer comprises repeating anhydroglucose units or a derivative thereof and the branch polymer comprises a residue of an aliphatic polyester.

2. The graft polymer of claim 1, wherein the aliphatic polyester is poly(lactic acid) or a derivative thereof.

3. The graft polymer of any one of claim 1, wherein the graft polymer has a grafting density of about 2% to about 30%.

4. The graft polymer of any one of claim 1, wherein the backbone polymer comprises residues of amylose, amylopectin, derivatives thereof, or any combination thereof.

5. The graft polymer of any one of claim 1, wherein the backbone polymer comprises residues of amylose, amylose acetate, derivatives thereof, or a combination thereof.

6. The graft polymer of any one of claim 1, wherein the backbone polymer comprises from about 1% to about 40% of an amylose residue or a derivative thereof by weight and from about 60% to about 99% of an amylopectin residue or a derivative thereof by weight.

7. The graft polymer of any one of claim 1, wherein the graft polymer comprises repeating units with a formula represented by the following structure: 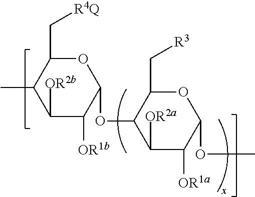
wherein,
R^{1a}, R^{2a}, R^{1b}, R^{2b}, and R³ are independently selected from hydrogen, a hydroxy group, an alkyl group, or an acyl group;
R⁴ is a linking agent selected from a secondary amine, a tertiary amine, an aryl group, an acyl group, or a thioether;
Q is the branch polymer; and
x ranges from 1 to 50.

8. The graft polymer of claim 7, wherein R^{1a}, R^{2a}, R^{1b}, R^{2b}, and R³ are independently selected from —C(O)R₂₀, wherein R₂₀ is a C1-C6 alkyl group.

9. The graft polymer of claim 7, wherein R⁴ is an aryl heterocycle.

10. The graft polymer of claim 7, wherein x ranges from 1 to 25.

11. A graft polymer, comprising at least two repeating units with formulas represented by the following structures: 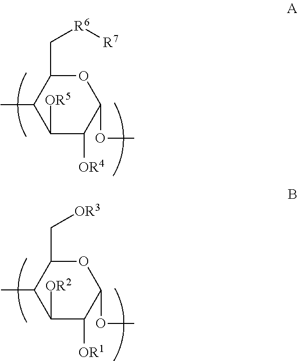
wherein,
R¹, R², R³, R⁴, and R⁵ are independently selected from hydrogen, an alkyl group, or an acyl group;
R⁶ is a linking agent selected from a secondary amine, a tertiary amine, an aryl group, acyl group, or a thioether; and
R⁷ is a residue of an aliphatic polyester.

12. The graft polymer of claim 11, wherein R¹, R², R³, R⁴, and R⁵ are independently selected from —C(O)R₂₀, wherein R₂₀ is a C1-C6 alkyl group.

13. The graft polymer of claim 11, wherein R⁶ is an aryl heterocycle.

14. The graft polymer of claim 11, wherein R⁷ is a poly(lactic acid) residue.

15. The graft polymer of claim 11, wherein a ratio of repeating units of structure A to repeating units of structure B present in the graft polymer ranges from about 1:30 to about 1:1 (A:B).

16. A method for making a polymer, comprising:
mixing together a first polymer and a first organic solvent, thereby forming a first mixture;
mixing together the first mixture, a first solution, and a second solution, thereby forming a second mixture;
mixing together the second mixture and a carboxylic acid anhydride, thereby forming a third mixture comprising an esterified polymer; and
isolating the esterified polymer from the third mixture;
wherein the first solution comprises triphenylphosphine (PPh₃) and a second organic solvent;
wherein the second solution comprises N-bromosuccinimide (NBS) and a third organic solvent; and
wherein the first polymer comprises repeating units of anhydroglucose or a derivative thereof.

17. The method of claim 16, wherein the esterified polymer has a degree of substitution of bromide of less than about 0.3.

18. The method of claim 16, further comprising:
dissolving the esterified polymer in a solvent, thereby forming an esterified polymer solution;
mixing together the esterified polymer solution and an azide salt, thereby forming a fourth mixture comprising an azide-functionalized polymer;
isolating the azide-functionalized polymer from the fourth mixture;
dissolving the azide-functionalized polymer and an aliphatic polyester or aliphatic polyester derivative in a solvent, thereby forming a graft polymer mixture;
mixing together the graft polymer mixture with a catalyst solution, comprising Cu(I)Br, PMDETA, and ascorbic acid, thereby forming a final polymer mixture comprising a graft polymer; and
isolating the graft polymer from the final polymer mixture.

19. The method of claim 18, wherein the graft polymer has a number average molecular weight of 400 kDa to about 3500 kDa.

20. The method of claim 19, wherein the aliphatic polyester or aliphatic polyester derivative is poly(lactic acid) or a derivative thereof.
